(19) United States
(12) Patent Application Publication
(10) Pub. No.: US 2025/0386309 A1
(43) Pub. Date: Dec. 18, 2025

(54) TECHNIQUES FOR SYNCHRONIZATION SIGNAL BLOCK DETECTION BASED ON PRIMARY SYNCHRONIZATION SIGNAL SYNCHRONIZATION SIGNAL BLOCK RANGE SIGNALING

(71) Applicant: QUALCOMM Incorporated, San Diego, CA (US)

(72) Inventors: Kiran VENUGOPAL, Green Brook, NJ (US); Yan ZHOU, San Diego, CA (US); Tao LUO, San Diego, CA (US); Raghu Narayan CHALLA, San Diego, CA (US); Yongle WU, San Diego, CA (US); Yong LI, San Diego, CA (US)

(21) Appl. No.: 18/747,133

(22) Filed: Jun. 18, 2024

(51) Int. Cl. H04W 56/00; H04W 8/22; H04W 24/08

(52) U.S. Cl. CPC H04W 56/0015; H04W 8/22; H04W 24/08

(57) ABSTRACT

Methods, systems, and devices for wireless communications are described. A user equipment (UE) may detect a peak primary synchronization signal (PSS) from a PSS burst. The PSS burst may include a plurality of PSSs that correspond to a plurality of synchronization signal blocks (SSBs) of a SSB burst scheduled within an SSB detection window that follows the PSS burst. One or more resources blocks, within a time duration corresponding to the peak PSS, may be decoded to identify an SSB position ID. The SSB position ID may map to a subset of SSB IDs of the SSB burst. A reduced portion of the SSB detection window that includes the SSBs corresponding to the subset of SSB IDs may be determined, and the UE may search the reduced SSB detection window for an SSB corresponding to the peak PSS. The UE may use the SSB for completing a cell identification process.

### FIELD OF TECHNOLOGY

The following relates to wireless communications, including techniques for synchronization signal block detection based on primary synchronization signal synchronization signal block range signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include detecting, based on a signal quality measurement, a first primary synchronization signal (PSS) from a set of multiple PSSs of a PSS burst, where the set of multiple PSSs correspond to a set of multiple synchronization signal blocks (SSBs) scheduled within an SSB detection window, decoding, within a time duration corresponding to the first PSS, one or more resource blocks to identify an SSB position identification (ID), where the SSB position ID maps to a subset of SSB IDs of a set of multiple SSB IDs corresponding to the set of multiple SSBs, where the subset of SSB IDs include two or more SSB IDs, and monitoring, during a portion of the SSB detection window including the subset of SSB IDs, for a first SSB corresponding to the first PSS.

A UE for wireless communications is described. The UE may include one or more memories storing processor executable code, and one or more processors coupled with the one or more memories. The one or more processors may individually or collectively be operable to execute the code to cause the UE to detect, based on a signal quality measurement, a first PSS from a set of multiple PSSs of a PSS burst, where the set of multiple PSSs correspond to a set of multiple synchronization signal blocks (SSBs) scheduled within an SSB detection window, decode, within a time duration corresponding to the first PSS, one or more resource blocks to identify an SSB position identification (ID), where the SSB position ID maps to a subset of SSB IDs of a set of multiple SSB IDs corresponding to the set of multiple SSBs, where the subset of SSB IDs include two or more SSB IDs, and monitor, during a portion of the SSB detection window including the subset of SSB IDs, for a first SSB corresponding to the first PSS.

Another UE for wireless communications is described. The UE may include means for detecting, based on a signal quality measurement, a first PSS from a set of multiple PSSs of a PSS burst, where the set of multiple PSSs correspond to a set of multiple synchronization signal blocks (SSBs) scheduled within an SSB detection window, means for decoding, within a time duration corresponding to the first PSS, one or more resource blocks to identify an SSB position identification (ID), where the SSB position ID maps to a subset of SSB IDs of a set of multiple SSB IDs corresponding to the set of multiple SSBs, where the subset of SSB IDs include two or more SSB IDs, and means for monitoring, during a portion of the SSB detection window including the subset of SSB IDs, for a first SSB corresponding to the first PSS.

A non-transitory computer-readable medium storing code for wireless communications is described. The code may include instructions executable by one or more processors to detect, based on a signal quality measurement, a first PSS from a set of multiple PSSs of a PSS burst, where the set of multiple PSSs correspond to a set of multiple synchronization signal blocks (SSBs) scheduled within an SSB detection window, decode, within a time duration corresponding to the first PSS, one or more resource blocks to identify an SSB position identification (ID), where the SSB position ID maps to a subset of SSB IDs of a set of multiple SSB IDs corresponding to the set of multiple SSBs, where the subset of SSB IDs include two or more SSB IDs, and monitor, during a portion of the SSB detection window including the subset of SSB IDs, for a first SSB corresponding to the first PSS.

Some examples of the method, user equipment (UEs), and non-transitory computer-readable medium described herein may further include operations, features, means, or instructions for receiving, via control signaling, an indication of a mapping that associates SSB position IDs to corresponding subsets of SSB IDs, an indication of a mapping rule for determining the mapping that associates SSB position IDs to corresponding subsets of SSB IDs, or both.

In some examples of the method, user equipment (UEs), and non-transitory computer-readable medium described herein, the UE may be preconfigured with a mapping that associates SSB position IDs to corresponding subsets of SSB IDs, or preconfigured with a mapping rule for determining the mapping that associates SSB position IDs to corresponding subsets of SSB IDs, or both.

In some examples of the method, user equipment (UEs), and non-transitory computer-readable medium described herein, the one or more resource blocks including the SSB position ID may be frequency division multiplexed in a same symbol as the first PSS.

In some examples of the method, user equipment (UEs), and non-transitory computer-readable medium described herein, the SSB position ID may be indicated in a quantity of bits carried in the one or more resource blocks.

In some examples of the method, user equipment (UEs), and non-transitory computer-readable medium described herein, the quantity of bits indicating the SSB position ID may be based on a frequency range associated with the UE, a frequency associated with the UE, a sub-carrier spacing associated with the UE, a duplex capability associated with the UE, or any combination thereof.

In some examples of the method, user equipment (UEs), and non-transitory computer-readable medium described herein, a quantity of SSB IDs in the subset of SSB IDs may be based on the quantity of bits indicating the SSB position ID.

In some examples of the method, user equipment (UEs), and non-transitory computer-readable medium described herein, the portion of the SSB detection window includes a reduced portion of the SSB detection window.

In some examples of the method, user equipment (UEs), and non-transitory computer-readable medium described herein, the portion of the SSB detection window includes SSBs, of the set of multiple SSBs, that correspond to the subset of SSB IDs, and excludes one or more SSBs, of the set of multiple SSBs, that do not correspond to the subset of SSB IDs, and where monitoring for the first SSB corresponding to the first PSS may include operations, features, means, or instructions for decoding the SSBs that correspond to the subset of SSB IDs and refraining from decoding the one or more SSBs that do not correspond to the subset of SSB IDs.

In some examples of the method, user equipment (UEs), and non-transitory computer-readable medium described herein, monitoring for the first SSB corresponding to the first PSS may include operations, features, means, or instructions for detecting, based on decoding the SSBs that correspond to the subset of SSB IDs, the first SSB corresponding to the first PSS.

In some examples of the method, user equipment (UEs), and non-transitory computer-readable medium described herein, monitoring for the first SSB corresponding to the first PSS may include operations, features, means, or instructions for determining, based on decoding the SSBs that correspond to the subset of SSB IDs, that the first SSB corresponding to the first PSS may be not detected, discarding, based on the first SSB not being detected, the first PSS, and monitoring, during a second SSB detection window, for a second set of multiple PSSs of a second PSS burst.

Some examples of the method, user equipment (UEs), and non-transitory computer-readable medium described herein may further include operations, features, means, or instructions for receiving, from a network entity and via control signaling, a message indicating a capability for SSB ID range signaling.

Some examples of the method, user equipment (UEs), and non-transitory computer-readable medium described herein may further include operations, features, means, or instructions for transmitting, to a network entity and via control signaling, a message indicating a capability to support SSB ID range signaling.

A method for wireless communications by a network entity is described. The method may include outputting, to a UE, a primary synchronization symbol (PSS) burst including a set of multiple PSSs, where the set of multiple PSSs correspond to a set of multiple synchronization signal blocks (SSBs) scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs, outputting, to the UE during the SSB detection window, a SSB burst including the set of multiple SSBs, and communicating with the UE on resources based on an SSB of the set of multiple SSBs.

A network entity for wireless communications is described. The network entity may include one or more memories storing processor executable code, and one or more processors coupled with the one or more memories. The one or more processors may individually or collectively be operable to execute the code to cause the network entity to output, to a UE, a primary synchronization symbol (PSS) burst including a set of multiple PSSs, where the set of multiple PSSs correspond to a set of multiple synchronization signal blocks (SSBs) scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs, output, to the UE during the SSB detection window, a SSB burst including the set of multiple SSBs, and communicate with the UE on resources based on an SSB of the set of multiple SSBs.

Another network entity for wireless communications is described. The network entity may include means for outputting, to a UE, a primary synchronization symbol (PSS) burst including a set of multiple PSSs, where the set of multiple PSSs correspond to a set of multiple synchronization signal blocks (SSBs) scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs, means for outputting, to the UE during the SSB detection window, a SSB burst including the set of multiple SSBs, and means for communicating with the UE on resources based on an SSB of the set of multiple SSBs.

A non-transitory computer-readable medium storing code for wireless communications is described. The code may include instructions executable by one or more processors to output, to a UE, a primary synchronization symbol (PSS) burst including a set of multiple PSSs, where the set of multiple PSSs correspond to a set of multiple synchronization signal blocks (SSBs) scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs, output, to the UE during the SSB detection window, a SSB burst including the set of multiple SSBs, and communicate with the UE on resources based on an SSB of the set of multiple SSBs.

In some examples of the method, network entities, and non-transitory computer-readable medium described herein, the one or more resource blocks including the respective SSB position ID may be frequency division multiplexed in a same symbol as an associated PSS.

In some examples of the method, network entities, and non-transitory computer-readable medium described herein, the respective SSB position ID may be indicated in a quantity of bits carried in the one or more resource blocks.

In some examples of the method, network entities, and non-transitory computer-readable medium described herein, the quantity of bits indicating the respective SSB position ID may be based on a frequency range associated with the UE, a frequency associated with the UE, a sub-carrier spacing associated with the UE, a duplex capability associated with the UE, or any combination thereof.

In some examples of the method, network entities, and non-transitory computer-readable medium described herein, a quantity of SSB IDs in the subset of SSB IDs may be based on the quantity of bits indicating the respective SSB position ID.

Some examples of the method, network entities, and non-transitory computer-readable medium described herein may further include operations, features, means, or instructions for outputting, to the UE and via control signaling, a mapping that associates SSB position IDs to corresponding subsets of SSB IDs, a mapping rule, or a combination thereof.

Some examples of the method, network entities, and non-transitory computer-readable medium described herein may further include operations, features, means, or instructions for outputting, to the UE and via control signaling, a message indicating a capability for SSB ID range signaling.

Some examples of the method, network entities, and non-transitory computer-readable medium described herein may further include operations, features, means, or instructions for obtaining, from the UE and via control signaling, a message indicating a capability to support SSB ID range signaling.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for synchronization signal block detection based on primary synchronization signal synchronization signal block range signaling in accordance with one or more aspects of the present disclosure.

FIG. 2 shows an example of a portion of a wireless communications system that supports techniques for synchronization signal block detection based on primary synchronization signal synchronization signal block range signaling in accordance with one or more aspects of the present disclosure.

FIG. 3 shows an example of a signaling design that supports techniques for synchronization signal block detection based on primary synchronization signal synchronization signal block range signaling in accordance with one or more aspects of the present disclosure.

FIG. 4 shows an example of a signaling design that supports techniques for synchronization signal block detection based on primary synchronization signal synchronization signal block range signaling in accordance with one or more aspects of the present disclosure.

FIG. 5 shows an example of a signaling design that supports techniques for synchronization signal block detection based on primary synchronization signal synchronization signal block range signaling in accordance with one or more aspects of the present disclosure.

FIG. 6 shows an example of a signaling design that supports techniques for synchronization signal block detection based on primary synchronization signal synchronization signal block range signaling in accordance with one or more aspects of the present disclosure.

FIG. 7 shows an example of a process flow that supports techniques for synchronization signal block detection based on primary synchronization signal synchronization signal block range signaling in accordance with one or more aspects of the present disclosure.

FIGS. 8 and 9 show block diagrams of devices that support techniques for synchronization signal block detection based on primary synchronization signal synchronization signal block range signaling in accordance with one or more aspects of the present disclosure.

FIG. 10 shows a block diagram of a communications manager that supports techniques for synchronization signal block detection based on primary synchronization signal synchronization signal block range signaling in accordance with one or more aspects of the present disclosure.

FIG. 11 shows a diagram of a system including a device that supports techniques for synchronization signal block detection based on primary synchronization signal synchronization signal block range signaling in accordance with one or more aspects of the present disclosure.

FIGS. 12 and 13 show block diagrams of devices that support techniques for synchronization signal block detection based on primary synchronization signal synchronization signal block range signaling in accordance with one or more aspects of the present disclosure.

FIG. 14 shows a block diagram of a communications manager that supports techniques for synchronization signal block detection based on primary synchronization signal synchronization signal block range signaling in accordance with one or more aspects of the present disclosure.

FIG. 15 shows a diagram of a system including a device that supports techniques for synchronization signal block detection based on primary synchronization signal synchronization signal block range signaling in accordance with one or more aspects of the present disclosure.

FIGS. 16 and 17 show flowcharts illustrating methods that support techniques for synchronization signal block detection based on primary synchronization signal synchronization signal block range signaling in accordance with one or more aspects of the present disclosure.

### DETAILED DESCRIPTION

Various aspects of the present disclosure relate to techniques for a range signaling synchronization signal block (SSB) identifiers (ID) s to a user equipment (UE) to reduce an SSB search space complexity during an initial cell search procedure. In some implementations, the UE and a network entity may be configured to support dual-burst synchronization signaling during the initial cell search procedure. The dual burst synchronization signal may include a single-symbol discovery reference signal (DRS) burst, such as a primary synchronization signal (PSS) burst, followed by a corresponding multi-symbol synchronization signal block (SSB) burst that is output during an SSB detection window. A peak PSS may be detected from the PSS burst by a UE, and the UE may search the SSB detection window for an SSB corresponding to the peak PSS. The corresponding SSB may carry a secondary synchronization signal (SSS) and a physical broadcast channel (PBCH). Together, the PSS and the SSS may provide the UE with the synchronization information necessary to demodulate the PBCH to access further system information that may enable the UE to communicate with the network. In some cases, a location of the SSB corresponding to the peak PSS may be ambiguous and the UE may blindly search the full SSB detection window for the SSB. This may result in high energy consumption at the UE, increased latency associated with access, among other technical challenges. In accordance with aspects described herein, to avoid or reduce the need of a blind search of the full SSB detection window for the SSB that corresponds to the peak PSS, the PSS may carry an indication of a range of candidate locations, within the SSB detection window, where the corresponding SSB may be located. Based on the range of candidate locations, the UE may search a reduced portion of the SSB detection window for the SSB that corresponds to the detected PSS. Such SSB range signaling may enable the network to transmit SSB bursts less frequently and may enable the UE to monitor a reduced SSB detection window for an SSB, thereby reducing power consumption at both the network and the UE, reducing latency, among other technical advantages.

Aspects of the disclosure are initially described in the context of wireless communications systems. Aspects of the disclosure are further illustrated by and described herein with reference to apparatus diagrams, system diagrams, and flowcharts that relate to techniques for synchronization signal block detection based on primary synchronization signal synchronization signal block range signaling.

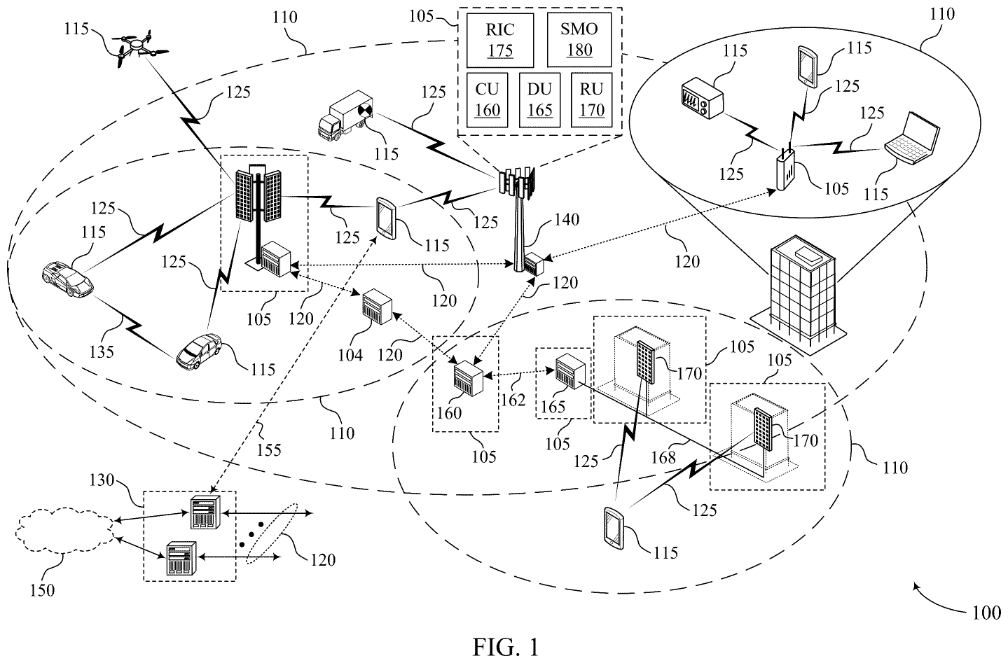

FIG. 1 shows an example of a wireless communications system 100 that supports techniques for synchronization signal block detection based on primary synchronization signal synchronization signal block range signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In accordance with aspects described herein, a UE 115 may be configured to support dual-burst synchronization signaling during an initial cell search procedure. For instance, to aid the UE 115 in cell discovery during an initial cell search procedure, a network entity 105 may repeatedly transmit dual-burst synchronization signals over different beams and in different spatial directions. The dual burst synchronization signal may include a single-symbol discovery reference signal (DRS) burst, such as a one-symbol primary synchronization signal (PSS) burst, followed by a multi-symbol synchronization signal block burst (SSB). Each PSS burst may include a plurality of PSS and each SSB burst may include a plurality of SSBs that correspond to the plurality of PSSs. The UE 115 may monitor for a PSS burst and may detect a peak PSS among the PSS burst. The detected PSS may provide the UE 115 with an initial (e.g., a coarse) timing and frequency synchronization for connecting to a cell. More precise timing and frequency synchronization may be provided to the UE 115 by a secondary synchronization signal (SSS), which enables the UE 115 to identify and accurately align with the specific cell serving the UE 115. Together, the PSS and the SSS may provide the UE 115 with the synchronization information necessary to demodulate the physical broadcast channel (PBCH) to access further system information enabling the UE 115 to communicate with the network. The SSS may be carried in an SSB, of the SSB burst, that corresponds to the detected PSS. In some cases, to avoid the need for the UE 115 to blindly search a full SSB detection window (e.g., a detection window associated with the plurality of SSBs of the SSB burst) for the SSB that corresponds to the detected PSS, the PSS may provide an indication of a location of the corresponding SSB within the SSB detection window. For instance, the PSS, in some cases, may carry a position identifier (ID) that indicates a range of candidate locations, within the SSB detection window, for the corresponding SSB. Accordingly, based on a mapping between position IDs and a range of candidate SSB locations, the UE 115 may search a reduced portion of the SSB detection window for the SSB that corresponds to the detected PSS. The UE 115 may detect the corresponding SSB in the reduced SSB detection window and may decode the SSB to identify an SSS sequence to obtain the refined timing and frequency synchronization for the cell. Such SSB range signaling may enable the network entity 105 to transmit SSB bursts less frequently and may enable the UE 115 to monitor a reduced SSB detection window for an SSB, thereby reducing power consumption at both the network entity 105 and the UE 115.

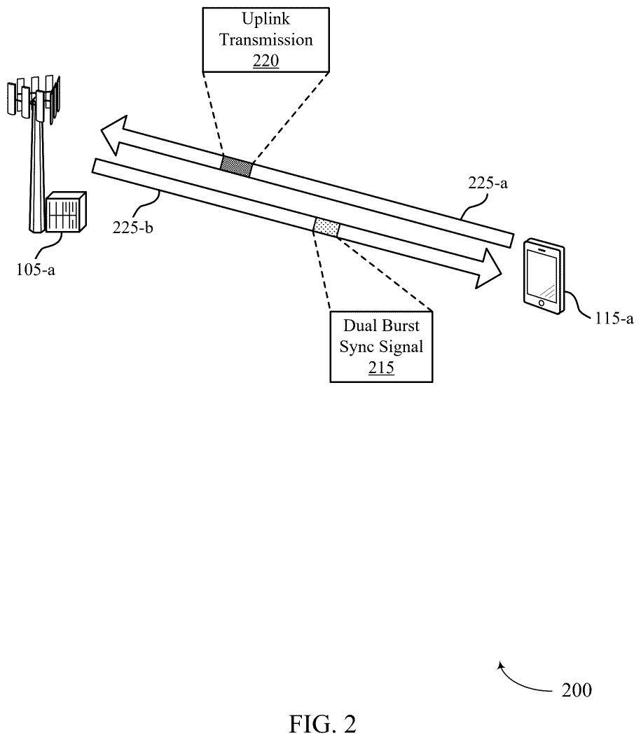

FIG. 2 shows an example of a portion of a wireless communications system 200 that supports techniques for synchronization signal block detection based on primary synchronization signal synchronization signal block range signaling in accordance with one or more aspects of the present disclosure. The wireless communications system 200 may include a network entity 105-a and a UE 115-a, which may be examples of network entities 105 and UEs 115, respectively, described herein with reference to FIG. 1. The network entity 105-a and UE 115-a may communicate using communication links (e.g., a Uu link) over which the UE 115-a may transmit uplink communications, such as uplink transmission 220, to the network entity 105-a, via an uplink channel 225-a; and which the network entity 105-a may transmit downlink communications, such as a dual-burst synchronization signal 215, to the UE 115-a, via a downlink channel 225-b.

The dual-burst synchronization signal 215 may provide the UE 115-a with timing and frequency for synchronizing with the network entity 105-a during an initial cell search procedure. For instance, the dual-burst synchronization signal 215 may comprise an SS/PBCH block burst that is separated into and transmitted by the network entity 105-a in two distinct bursts, such as in a first DRS burst for initial cell discovery and coarse timing and frequency synchronization and a second SSB burst for more precise timing and frequency synchronization. For instance, the dual-burst synchronization signal 215 may be separated into a single-symbol DRS burst followed by a multi-symbol SSB burst. The single-symbol DRS burst may be a PSS burst that includes a plurality of single-symbol PSSs, and the multi-symbol SSB burst may include a plurality of multi-symbol SSBs that correspond to the plurality of single-symbol PSSs. As an example, each multi-symbol SSB may be a three-symbol SSB that includes two symbols for the PBCH and one symbol for SSS. The multi-symbol SSB, however, may comprise a different quantity of symbols for carrying the PBCH and SSS.

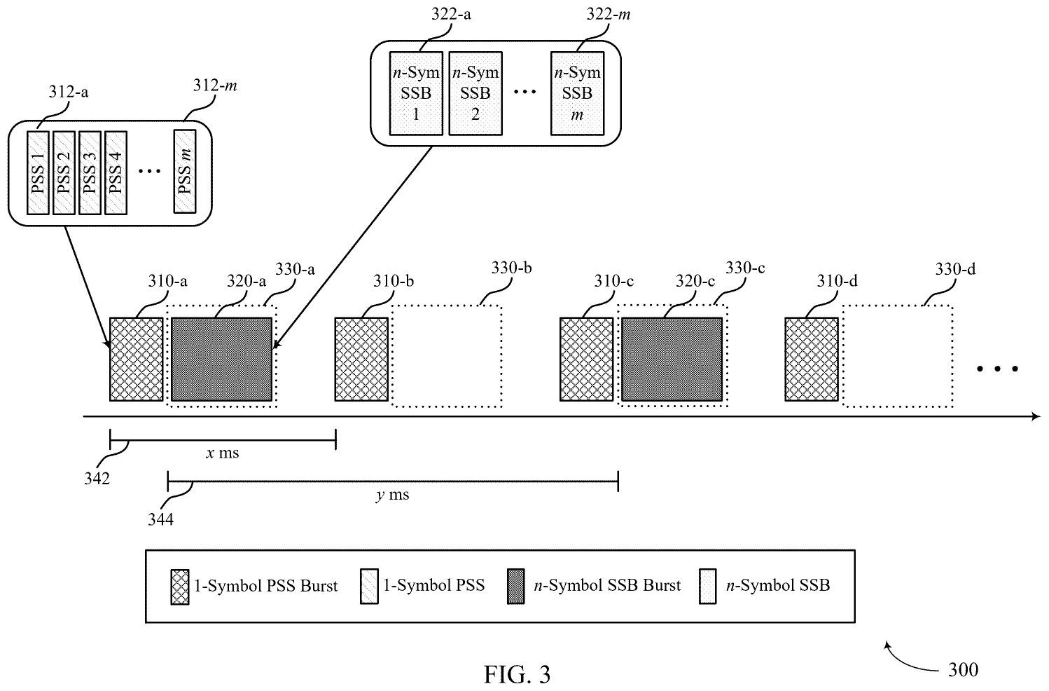

FIG. 3 shows an example of a signaling design 300 that supports techniques for synchronization signal block detection based on primary synchronization signal synchronization signal block range signaling in accordance with one or more aspects of the present disclosure. In some examples, signaling design 300 may be implemented by aspects of the wireless communications systems 100 and 200, as described herein with reference to FIGS. 1 and 2. For example, the UE 115-a and the network entity 105-a, described herein with reference to FIG. 2, may be configured to operate in accordance with the signaling design 300. The network entity 105-a may be configured to transmit, and the UE 115-a configured to receive, dual-burst synchronization signaling, such as the dual-burst synchronization signal 215, described herein with reference to FIG. 2.

The dual-burst signaling may include an SS/PBCH block burst that is separated into and transmitted in two distinct bursts. For instance, the SS/PBCH block burst may be separated into a first DRS burst for initial cell discovery and coarse timing and frequency synchronization, followed by a second SSB burst for cell identification and more precise timing and frequency synchronization. In some implementations, the DRS burst may be a single-symbol PSS burst, such as PSS burst 310, that includes a plurality of single-symbol PSSs 312 (e.g., PSSs 312-a to 312-m). The single-symbol PSS 312 may be a one-symbol common PSS or limited search hypothesis. The SSB burst may be a multi-symbol SSB burst, such as SSB burst 320, that includes a plurality of multi-symbol SSBs 322 (e.g., SSBs 322-a to 322-m) that correspond to the plurality of single-symbol PSSs 312. As an example, the SSB 322 may be a three-symbol SSB 322 that includes a two-symbol PBCH and a one-symbol cell-specific SSS. In some implementations, the SSB burst 320 (e.g., the multi-symbol SSB) may include SSBs having a different quantity of symbols for carrying the PBCH and SSS. A quantity of PSSs 312 or SSB 322 carried in a corresponding PSS burst 310 or SSB burst 320 may be dependent on a frequency range (FR), a frequency, an SCS, duplex capabilities, or other factors associated with the UE 115-a, the network entity 105-a, or both.

The network entity 105-a may transmit the PSS burst 310 followed by the corresponding SSB burst 320. The SSB burst 320 may be transmitted during an SSB detection window 330. For instance, when the SSB burst 320 is a three-symbol SSB burst, the SSB detection window 330 may be a four-symbol duration detection window based on the three-symbol SSB burst duration and a one-symbol gap.

The dual-burst synchronization signal carrying the PSS burst 310 followed by the SSB burst 320 may be transmitted by the network entity 105-a over different transmission beams to cover different spatial areas covered by the network entity 105-a. That is, one or more of the PSSs 312 of the PSS burst 310 and one or more of the corresponding SSBs 322 of the SSB burst 320 may be transmitted over different transmission beams, such as in different spatial directions, and each of the SSBs 322 may correspond to or provide an indication of a particular transmission beam that transmitted that SSB 322 and corresponding PSS 312.

Additionally, the dual-burst synchronization signal carrying the PSS burst 310 and the SSB burst 320 may be transmitted by the network entity 105-a repeatedly. That is, the network entity 105-a may repeatedly transmit the PSS burst 310 followed by a corresponding SSB burst 320 in a corresponding SSB detection window 330. In some cases, the network entity 105-a may transmit repetitions of the PSS burst 310 and repetitions of the SSB burst 320 at different periodicities from one another. For instance, the network entity 105-a may transmit each PSS burst 310, such as a first PSS burst 310-a, a second PSS burst 310-b, a third PSS burst 310-c, a fourth PSS burst 310-d, etc., in accordance with a first periodicity 342 and may transmit each SSB burst 320, such as a first SSB burst 320-a during an SSB detection window 330-a, a second SSB burst 320-c during an SSB detection window 330-c, etc., in accordance with a second periodicity 344. In some cases, the second periodicity 344 may be associated with less frequent transmission of the SSB bursts 320 than the first periodicity 342 associated with transmission of the PSS bursts 310. For instance, the first periodicity 342 may be every 20 milliseconds (ms) and the second periodicity 344 may be every 40 ms. As a result, in some instances, a PSS burst 310 may be transmitted without an SSB burst 320 being transmitted during a corresponding SSB detection window 330. For instance, PSS burst 310-b and PSS burst 310-d may be transmitted without a corresponding SSB burst being transmitted in respective SSB detection window 330-b and SSB detection window 330-d.

The UE 115-a may periodically monitor for and receive one or more of the PSS bursts 310, such as the first PSS burst 310-a. The UE 115-a may detect a peak PSS 312 from the PSS burst 310. For instance, the UE 115-a may detect a PSS 312 with a signal quality measurement that satisfies a threshold. The UE 115-a may subsequently monitor an immediately following SSB detection window 330, such as SSB detection window 330-a, for an SSB burst 320, such as to monitor for SSB burst 320-a, to identify an SSB 322 of the SSB burst 320-a that corresponds to the detected peak PSS 312. In some cases, however, because the detected peak PSS 312 may not be carried in a single SS/PBCH block (such as together with the SSB, e.g., the SSS and PBCH) and may, instead, be carried in the dual-burst synchronization signal, a location of the SSB 322 that corresponds to the detected peak PSS 312 may be ambiguous. That is, because the plurality of PSSs 312 transmitted on the different transmission beams are transmitted back-to-back in a single PSS burst 310 and because the corresponding SSBs 322 are likewise transmitted back-to-back in a single SSB burst 320 (e.g., after transmission of each of the PSSs 312 in the PSS burst 310), and also because the SSB bursts 320 are transmitted less frequently than the PSS bursts 310, the location of a particular SSB 322 that corresponds with a particular PSS 312 may be ambiguous. In such cases, the UE 115-a may have to blindly search a full SSB detection window 330 that follows the PSS burst 310 to locate the corresponding SSB 322. Such blind searching of one or more of the SSB detection windows 330 may negatively impact power consumption at the UE 115-a.

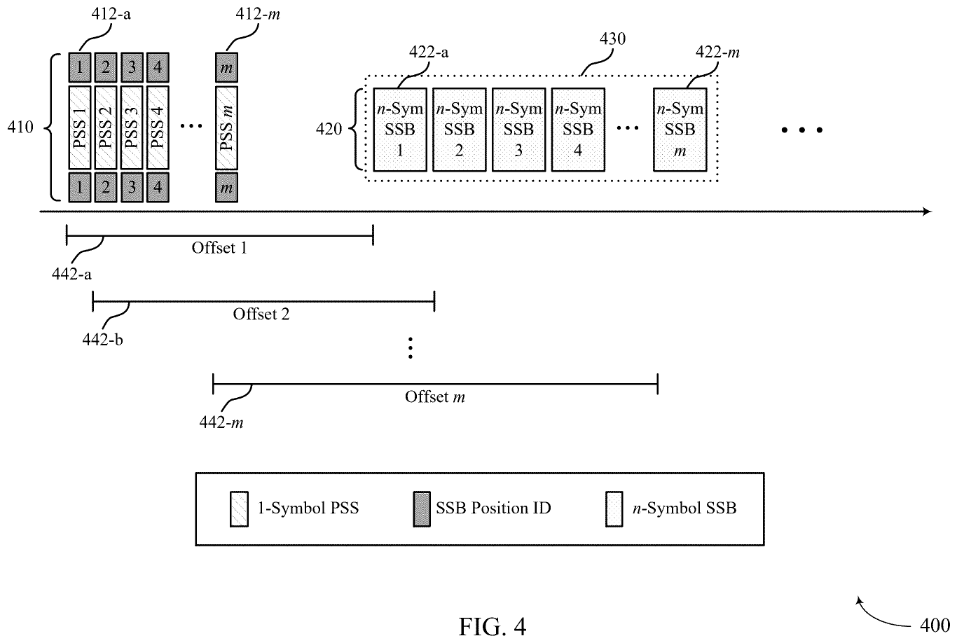

FIG. 4 shows an example of a signaling design 400 that supports techniques for synchronization signal block detection based on primary synchronization signal synchronization signal block range signaling in accordance with one or more aspects of the present disclosure. In some examples, signaling design 400 may be implemented by aspects of the wireless communications systems 100 and 200 and signaling design 300, as described herein with reference to FIGS. 1, 2, and 3. For example, the UE 115-a and the network entity 105-a, described herein with reference to FIGS. 2 and 3, may be configured to operate in accordance with the signaling design 400.

In accordance with aspects described herein, to reduce the search space complexity associated with locating a SSB transmitted in a dual-burst synchronization signal and thereby reduce power consumption, one or more of the PSSs in a PSS burst may provide an indication of a location of a corresponding SSB within an SSB detection window. For instance, the network entity 105-a may transmit, and the UE 115-a may receive, a dual-burst synchronization signal including a PSS burst 410 followed by an SSB burst 420 during an SSB detection window 430. The PSS burst 410 may include a plurality of PSSs 412, such as PSS 412-a to 412-m. The SSB burst 420 may include a plurality of SSBs 422, such as SSB 422-a to 422-m. Each PSS 412 in the PSS burst 410 may have a corresponding SSB 422 in the SSB burst 420. As an example, PSS1 412-a may correspond to SSB1 422-a, and PSS2 may correspond to SSB2. Each PSS 412 may be separated from a corresponding SSB 422 in the time domain by an offset 442. For instance, PSS1 412-a may be separated from corresponding SSB1 442-a by a first offset 442-a, PSS2 may be separated from corresponding SSB2 by a second offset 442-b, etc. In some cases, offsets 442 may be the same. In other cases, the offsets 442 may be different.

In some implementations, to reduce the search space complexity associated with locating the SSB 422 corresponding to a PSS 412, the PSS 412 may carry a position ID that indicates a range of candidate locations, within the SSB detection window 440, that may carry the corresponding SSB 422. For instance, the position ID associated with a particular PSS 412 may be frequency division multiplexed in the same symbol as the PSS 412. For instance, the position ID may be carried in a quantity of resource blocks (RBs) above and a quantity of RBs below the PSS 412, such as 4 RBs above and 4 RBs below the PSS 412, using the same modulation coding scheme as used for the SSB transmission (e.g., SSB 422). The quantity of RBs above and below the PSS 412 may be referred to as extended RBs.

Accordingly, based on a mapping between position IDs and a range of candidate SSB locations as indicated by SSB IDs associated with the SSBs 422, the UE 115-a may utilize the position ID indicated in the extended RBs to identify a reduced portion of the SSB detection window 330 to monitor for the SSB 332 that corresponds to a PSS 412. For example, in the case of PSS1 412-a or PSS2, when the indication of the position ID is carried in the extended RBs, the reduced SSB detection window may be based on the second offset 442-b minus the first offset 442-a. While, when such an indication is not carried in the extended RBs, the SSB detection window may be based on m^{th} offset 442-m minus the first offset 442-a. In some cases, the UE 115-a may signal to the network entity 105-a its capability to support such functionality. In some cases, the network entity 105-a may broadcast in the network its capability to support such functionality.

Accordingly, the UE 115-a that supports such functionality may be preconfigured with a mapping or a look up table that associates position IDs with a range or subset of SSB IDs (such as one or more SSB IDs among a plurality of supported SSB IDs), such as shown below in Table 1.

TABLE 1

| Position | |
|---|---|
| ID | SSB ID |
| 1 | SSB1, SSB2, SSB3, SSB4, SSB5, SSB6, SSB7, SSB8 |
| 2 | SSB9, SSB10, SSB11, SSB12, SSB13, SSB14, SSB15, SSB16 |
| 3 | SSB17, SSB18, SSB19, SSB20, SSB21, SSB22, SSB23, SSB24 |
| 4 | SSB25, SSB26, SSB27, SSB28, SSB29, SSB30, SSB31, SSB32 |
| 5 | SSB33, SSB34, SSB35, SSB36, SSB37, SSB38, SSB39, SSB40 |
| 6 | SSB41, SSB42, SSB43, SSB44, SSB45, SSB46, SSB47, SSB48 |
| 7 | SSB49, SSB50, SSB51, SSB52, SSB53, SSB54, SSB55, SSB56 |
| 8 | SSB57, SSB58, SSB59, SSB60, SSB61, SSB62, SSB63, SSB64 |

In some cases, the mapping may be signaled to the UE 115-a in control signaling transmitted from the network entity 105-a. In some cases, the mapping may be based on a mapping rule. In such cases, the UE 115-a may be preconfigured with the mapping rule or the mapping rule may be signaled to the UE 115-a in control signaling transmitted from the network entity 105-a. An example mapping rule may be that the position ID is a maximum of N bits long and the first K SSB IDs within the SSB detection window are mapped to the first position ID, the next K SSB IDs are mapped to the second position ID, and so on. The UE 115-a may use the mapping rule to determine the mapping of position IDs to subsets of SSB IDs.

The mapping may be based on a frequency range (FR), a frequency, an SCS, duplex capabilities, or other factors associated with the UE 115-a, the network entity 105-a, or both. For instance, as shown in Table 2, a quantity of SSB IDs that may be associated with or supported by a given position ID, and a quantity of bits for carrying an SSB ID, may be based on an FR, a frequency, an SCS, duplex capabilities, or other factors associated with the UE 115-a, the network entity 105-a, or both. The quantity of bits used for carrying an SSB ID may be, for example, 2, 3, or 6 bits, based on the quantity of SSB IDs supported for a given frequency band or numerology. However, the quantity of bits used for carrying a position ID may be smaller than the quantity of bits used for carrying an SSB ID, since a range of SSB IDs may be mapped to a single position ID. In this way, resources (e.g., a quantity of bits) may be reduced from the perspective of the transmitting network entity 105-a, while an SSB detection window may also be reduced at the receiving UE 115-a, thereby further reducing complexity and power at the UE 115-a. Accordingly, such as when 8 position IDs are used, rather than using 6 bits to carry an SSB ID, 3 bits may instead be used to carry a corresponding position ID.

TABLE 2

| Qty of SSB | Qty of | |
|---|---|---|
| IDs | Bits for | |
| Supported | SSB ID | Factors |
| 4 | 2 bits | FR1 <= 3G for 15k SCS or FDD with 30k SCS |
| | | FR1 <= 1.88 for TDD with 30k SCS |
| 8 | 3 bits | FR1 <= 3G for 15k SCS or FDD with 30k SCS |
| | | FR1 <= 1.88 for TDD with 30k SCS |
| 64 | 6 bits | FR2 |

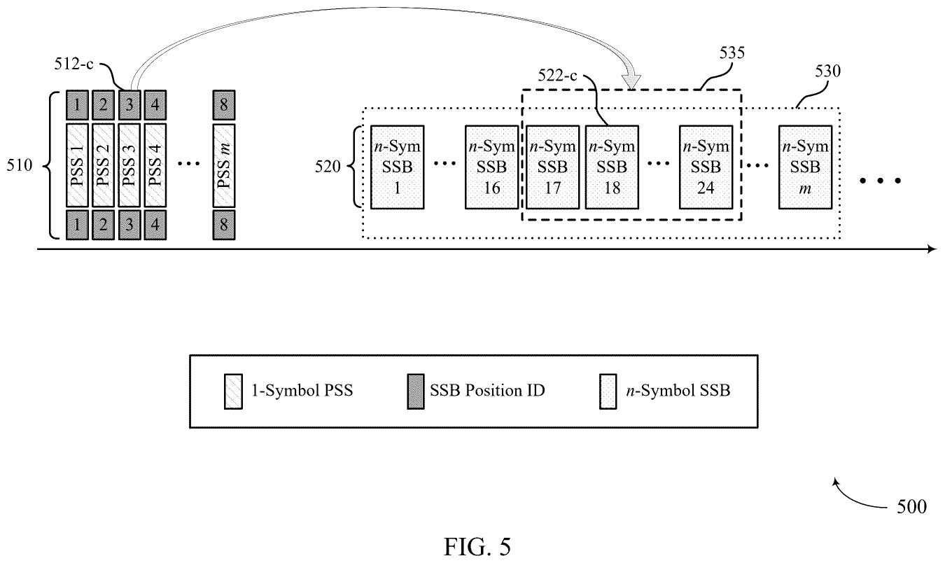

FIG. 5 shows an example of a signaling design 500 that supports techniques for synchronization signal block detection based on primary synchronization signal synchronization signal block range signaling in accordance with one or more aspects of the present disclosure. In some examples, signaling design 500 may be implemented by aspects of the wireless communications systems 100 and 200 and signaling designs 300 and 400, as described herein with reference to FIGS. 1, 2, 3, and 4. For example, the UE 115-a and the network entity 105-a, described herein with reference to FIGS. 2, 3, and 4, may be configured to operate in accordance with the signaling design 500.

In accordance with aspects described herein, to reduce the search space complexity associated with locating a SSB transmitted in a dual-burst synchronization signal, one or more of the PSSs in a PSS burst may carry a position ID that indicates a subset of SSB IDs (e.g., a range of SSB locations) of a corresponding SSB within an SSB detection window. For instance, the network entity 105-a may transmit, and the UE 115-a may receive, a dual-burst synchronization signal including a PSS burst 510 followed by an SSB burst 520. The PSS burst 510 may include a plurality of PSSs 512. The SSB burst 520 may include a plurality of SSBs 522 and may be transmitted during a SSB detection window 530.

For instance, the UE may initially monitor for the PSS burst 510 and may detect a peak PSS 512-c, such as PSS 3, among the PSS burst 510. Upon detecting the peak PSS 512-c, the UE 115-a may decode one or more RBs within the PSS 512-c symbol (e.g., the extended RBs) to obtain the position ID that may be frequency domain multiplexed with the detected peak PSS 512-c (e.g., decode the RBs above and below the PSS 512-c symbol to obtain the position ID). Based on a mapping between the position ID carried with the detected peak PSS 512-c and a subset of SSB IDs, the UE 115-a may determine a reduced SSB detection window 535 within the full SSB detection window 530. For instance, in this example, the UE 115-a may determine that the position ID carried with the detected peak PSS 512-c is position ID 3. Using the mapping (such as shown in Table 1), the UE 115-a may determine a subset of SSB IDs including SSB17, SSB18, SSB19, SSB20, SSB21, SSB22, SSB23, and SSB24 as candidate locations for the SSB 522 corresponding to the detected peak PSS 512-c. Accordingly, the UE 115-a may monitor the reduced SSB detection window 535 (including SSB17 through SSB24), instead of monitoring the full SSB detection window 530 (including SSB 1 through SSBm) to attempt to detect the SSB 522 corresponding to the detected peak PSS 512-c, such as by performing a blind search within the reduced SSB detection window 535 using n-symbols. For instance, the UE 115-a may determine that SSB 522-c, such as SSB18, corresponds to the detected peak PSS 512-c. In some cases, such as when the SSB bursts 520 are transmitted less frequently than the PSS bursts 510, there might not be an SSB burst 520 (and corresponding SSBs) in the SSB detection window 530 or the reduced SSB detection window 535. In this case, the UE 115-a may discard the detected peak PSS 512-c and monitor for a next peak PSS 512 such as in a next cycle or repletion of the dual-burst synchronization signal.

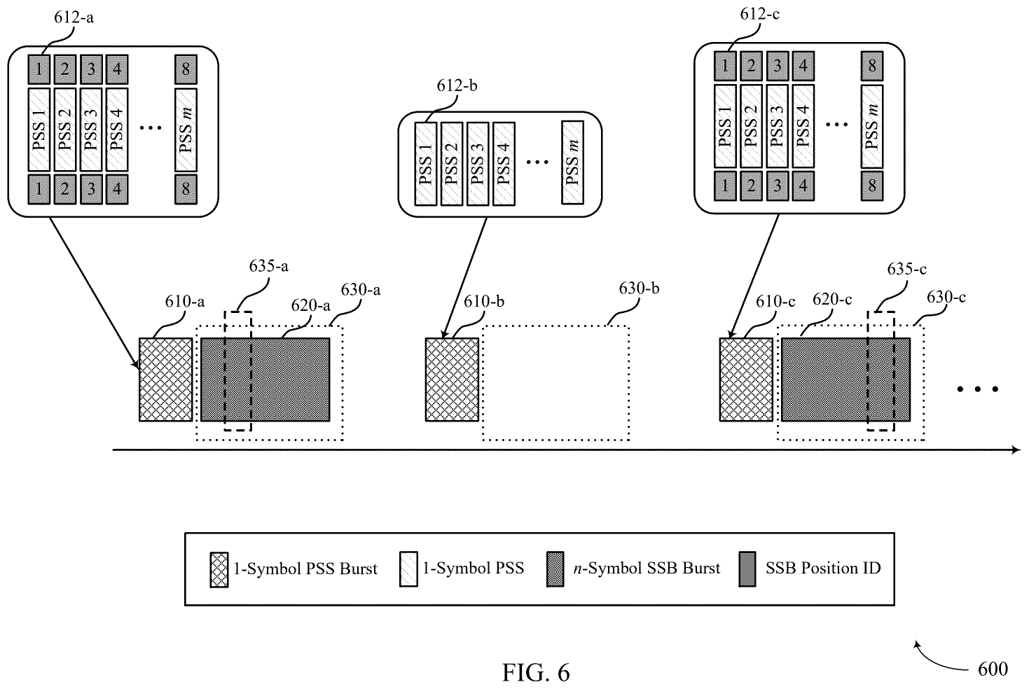

FIG. 6 shows an example of a signaling design 600 that supports techniques for synchronization signal block detection based on primary synchronization signal synchronization signal block range signaling in accordance with one or more aspects of the present disclosure. In some examples, signaling design 600 may be implemented by aspects of the wireless communications systems 100 and 200 and signaling designs 300, 400, and 500, as described herein with reference to FIGS. 1, 2, 3, 4, and 5. For example, the UE 115-a and the network entity 105-a, described herein with reference to FIGS. 2, 3, 4, and 5, may be configured to operate in accordance with the signaling design 600.

In accordance with aspects described herein, to reduce the search space complexity associated with locating a SSB transmitted in a dual-burst synchronization signal, one or more of the PSSs in a PSS burst may carry a position ID that indicates a subset of SSB IDs (e.g., a range of SSB locations) of a corresponding SSB within an SSB detection window, when the corresponding SSB burst is carried in the same period as the PSS burst. For instance, the network entity 105-a may repeatedly transmit the dual-burst synchronization signal. In some cases, the network entity 105-a transmit PSS bursts 610 of the dual-burst synchronization signal in accordance with a first periodicity that is different than a second periodicity used to transmit SSB bursts 620 of the dual-burst synchronization signal. For instance, the PSS bursts 610 may be transmitted more frequently than the SSB bursts 620. For example, the PSS bursts 610 may be transmitted every 20 ms, and the SSB bursts 620 may be transmitted every 40 ms. As a result, in some cases, the PSS burst 610 may be transmitted during a given period and a corresponding SSB burst 620 might not be transmitted during the same period.

For instance, PSS burst 610-a and corresponding SSB burst 620-a may be transmitted together in a first period, PSS burst 610-b may be transmitted in a second period without a corresponding SSB burst, and PSS burst 610-c and corresponding SSB burst 620-c may be transmitted together in a third period. In the case where the SSB burst 620 is transmitted in the same period as its corresponding PSS burst 610, one or more of the PSSs 612 of the PSS burst 610 may be transmitted with a position ID that is frequency domain multiplexed with the PSS 612.

For instance, in this example, since PSS burst 610-a and SSB burst 620-a are transmitted together in the first period, one or more of the PSSs 612-a of the PSS burst 610-a may carry a position ID indicating a subset of SSB IDs within the SSB burst 620-a where the SSB corresponding to that PSS 612-a may be located. As a result, upon detecting a peak PSS 612-a among the PSS burst 610-a, the UE 115-a may decode the extended RBs of the PSS 612-a to obtain the associated position ID. Based on a mapping of position IDs to subsets of SSB IDs, the UE 115-a may determine a reduced SSB detection window 635-a, within a full SSB detection window 630-a, that includes a subset of SSB IDs associated with the position ID. The UE 115-a may, thereafter, monitor the reduced SSB detection window 635-a for the SSB that corresponds to the detected peak PSS 612-a.

However, since no corresponding SSB burst is transmitted in the second period with PSS burst 610-b (e.g., an SSB burst is not transmitted during the SSB detection window 630-b), the PSSs 612-b of the PSS burst 610-b might not carry any position IDs. In this case, after detecting a peak PSS 612-b, the UE 115-a may attempt to decode the extended RBS of the peak PSS 612-b to obtain the position ID, and upon determining that no position ID is detected, the UE 115-a may discard the peak PSS 612-b and skip monitoring in the SSB detection window 630-b. The UE 115-a may monitor for a next instance of a PSS burst 610 until a peak PSS 612 that carries a position ID is detected.

For instance, during a next cycle or period, the UE 115-a may detect the PSS burst 610-c and a peak PSS 612-c among the PSS burst 610-c. The UE 115-a may decode the extended RBs of the PSS 612-c and obtain an associated position ID. Based on detecting the position ID, the UE 115-a may utilize the mapping of position IDs to subsets of SSB IDs to determine a subset of SSB IDs associated with the position ID and a corresponding reduced SSB detection window 635-c, within a full SSB detection window 630-c, that includes the subset of SSB IDs. The UE 115-a may, thereafter, monitor the reduced SSB detection window 635-c for the SSB that corresponds to the detected peak PSS 612-c.

Accordingly, by carrying the position ID with the PSS 612 only when the PSS burst 610 has a corresponding SSB burst 620 that is transmitted in the same period as the PSS burst 610, search space complexity may be further reduced.

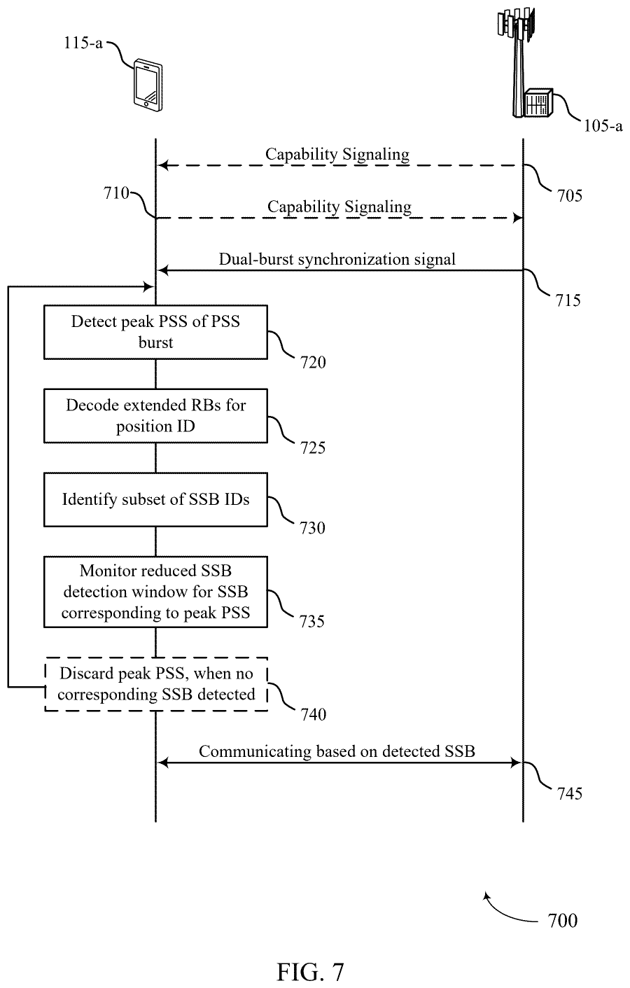

FIG. 7 shows an example of a process flow 700 that supports techniques for synchronization signal block detection based on primary synchronization signal synchronization signal block range signaling in accordance with one or more aspects of the present disclosure. In some examples, process flow 700 may implement aspects of wireless communications system 100 or 200 or the signaling designs 300, 400, 500, or 600, as described herein with reference to FIGS. 1 to 6. Process flow 700 may be implemented by the UE 115-a and network entity 105-a described herein with reference to FIGS. 2 to 6.

In the following description of the process flow 700, the communications between the UE 115-a and the network entity 105-a may be transmitted in a different order than the example order shown, or the operations performed by the UE 115-a and the network entity 105-a may be performed in different orders or at different times. Some operations may also be omitted from the process flow 700, and other operations may be added to the process flow 700. In some examples, the operations illustrated in process flow 700 may be performed by hardware (e.g., including circuitry, processing blocks, logic components, and other components), code (e.g., software or firmware) executed by a processor, or any combination thereof.

At step 705, the network entity 105-a may transmit (or broadcast), and the UE 115-a may receive, capability signaling indicating a capability by the network entity 105-a for SSB ID range signaling. For instance, the network entity 105-a may broadcast or transmit via control signaling, to the UE 115-a, a capability for SSB ID range signaling using position IDs carried by a PSS.

At step 710, alternatively or additionally, the UE 115-a may transmit, and the network entity 105-a may receive, capability signaling indicating a capability by the UE 115-a for supporting the SSB ID range signaling.

At step 715, the network entity 105-a may repeatedly transmit or output a dual-burst synchronization signal. For instance, the network entity 105-a may repeatedly transmit or output the dual-burst synchronization signal according to a periodicity during an SSB period, such as during an 80 ms period. The dual-burst synchronization signal may include one or more PSS bursts followed by one or more corresponding SSB bursts. Each PSS burst may include a plurality of PSSs that correspond to a plurality of SSBs in a corresponding SSB burst. The network entity 105-a may transmit or output one or more PSS bursts according to a first periodicity and may transmit or output one or more SSB bursts according to a second periodicity that may be different from the first periodicity.

At step 720, UE 115-a may detect a peak PSS of a PSS burst. For instance, the UE 115-a may monitor for and detect one of the PSS bursts output by the network entity 105-a. The UE 115-a may detect a peak PSS from among the plurality of PSSs of the PSS burst. For instance, the UE 115-a may detect the peak PSS based on a signal quality measurement of the PSS satisfying a threshold.

At step 725, the UE 115-a may decode extended RBs of the detected peak PSS to obtain a position ID. For instance, the UE 115-a may decode, within a time duration corresponding to the detected peak PSS, one or more extended RBs to obtain position ID. The position ID may be frequency domain multiplexed in the same symbol as the detected peak PSS and may provide an indication of candidate SSB locations within an SSB detection window that may include an SSB that corresponds to the detected peak PSS.

At step 730, the UE 115-a may identify a subset of SSB IDs corresponding to the position ID. For instance, the UE 115-a may identify the subset of SSB IDs corresponding to the position ID based on a mapping table associating position IDs to subsets of SSB IDs. Subset of SSB IDs may be two or more of a plurality of SSB IDs corresponding to the SSBs in the corresponding SSB burst.

At step 735, the UE 115-a may monitor during a reduced SSB detection window for an SSB corresponding to the detected peak PSS. For instance, the UE 115-a may determine a reduced portion of an SSB detection window following the PSS burst that includes the subset of SSB IDs, and the UE 115-a may monitor, during the reduced SSB detection window, for an SSB corresponding to the detected peak PSS.

At step 740, if no corresponding SSB detected, the UE 115-a may discard the peak PSS. For instance, if no position ID was detected when decoding the extended RBs or if no SSB burst is received in the SSB detection window following the PSS burst (e.g., during the same period as the PSS burst) the detected peak PSS may be discarded and the UE 115-a may continue to monitor for another PSS burst and associated peak PSS.

At 745, otherwise, if a corresponding SSB is detected, the UE 115-a and network entity 105-a may communicate with one another based on the detected SSB. For instance, the UE 115-a may utilize the SSB for time and frequency synchronization to the network entity 105-a and for demodulating a PBCH to access further system information indicating time and frequency resources to be used for communication with the network entity 105-a.

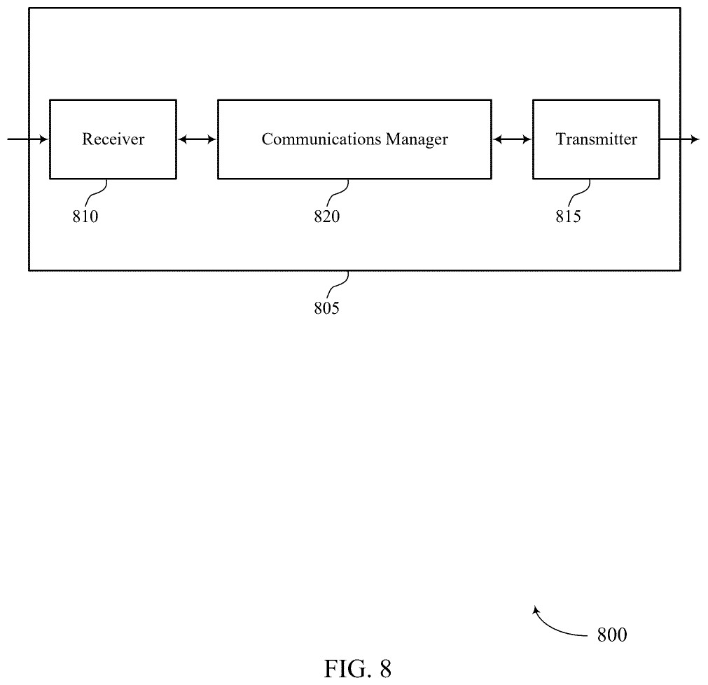

FIG. 8 shows a block diagram 800 of a device 805 that supports techniques for synchronization signal block detection based on primary synchronization signal synchronization signal block range signaling in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for synchronization signal block detection based on primary synchronization signal synchronization signal block range signaling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for synchronization signal block detection based on primary synchronization signal synchronization signal block range signaling). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of techniques for synchronization signal block detection based on primary synchronization signal synchronization signal block range signaling as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for detecting, based on a signal quality measurement, a first PSS from a set of multiple PSSs of a PSS burst, where the set of multiple PSSs correspond to a set of multiple SSBs scheduled within an SSB detection window. The communications manager 820 is capable of, configured to, or operable to support a means for decoding, within a time duration corresponding to the first PSS, one or more resource blocks to identify an SSB position ID, where the SSB position ID maps to a subset of SSB IDs of a set of multiple SSB IDs corresponding to the set of multiple SSBs, where the subset of SSB IDs include two or more SSB IDs. The communications manager 820 is capable of, configured to, or operable to support a means for monitoring, during a portion of the SSB detection window including the subset of SSB IDs, for a first SSB corresponding to the first PSS.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and latency, as well as reduced power consumption.

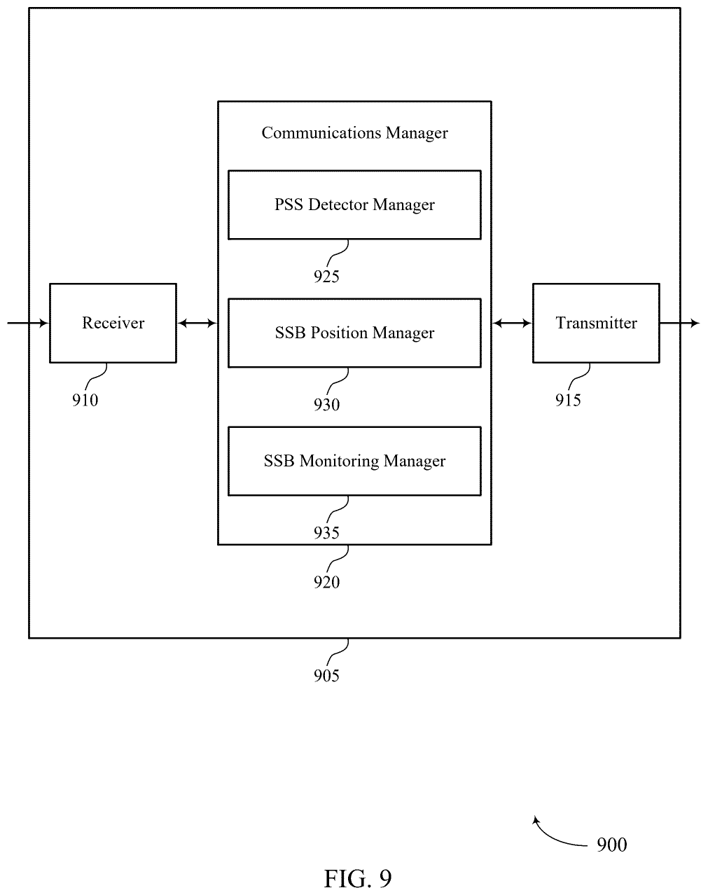

FIG. 9 shows a block diagram 900 of a device 905 that supports techniques for synchronization signal block detection based on primary synchronization signal synchronization signal block range signaling in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for synchronization signal block detection based on primary synchronization signal synchronization signal block range signaling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for synchronization signal block detection based on primary synchronization signal synchronization signal block range signaling). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for synchronization signal block detection based on primary synchronization signal synchronization signal block range signaling as described herein. For example, the communications manager 920 may include an PSS detector manager 925, an SSB position manager 930, an SSB monitoring manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The PSS detector manager 925 is capable of, configured to, or operable to support a means for detecting, based on a signal quality measurement, a first PSS from a set of multiple PSSs of a PSS burst, where the set of multiple PSSs correspond to a set of multiple SSBs scheduled within an SSB detection window. The SSB position manager 930 is capable of, configured to, or operable to support a means for decoding, within a time duration corresponding to the first PSS, one or more resource blocks to identify an SSB position ID, where the SSB position ID maps to a subset of SSB IDs of a set of multiple SSB IDs corresponding to the set of multiple SSBs, where the subset of SSB IDs include two or more SSB IDs. The SSB monitoring manager 935 is capable of, configured to, or operable to support a means for monitoring, during a portion of the SSB detection window including the subset of SSB IDs, for a first SSB corresponding to the first PSS.

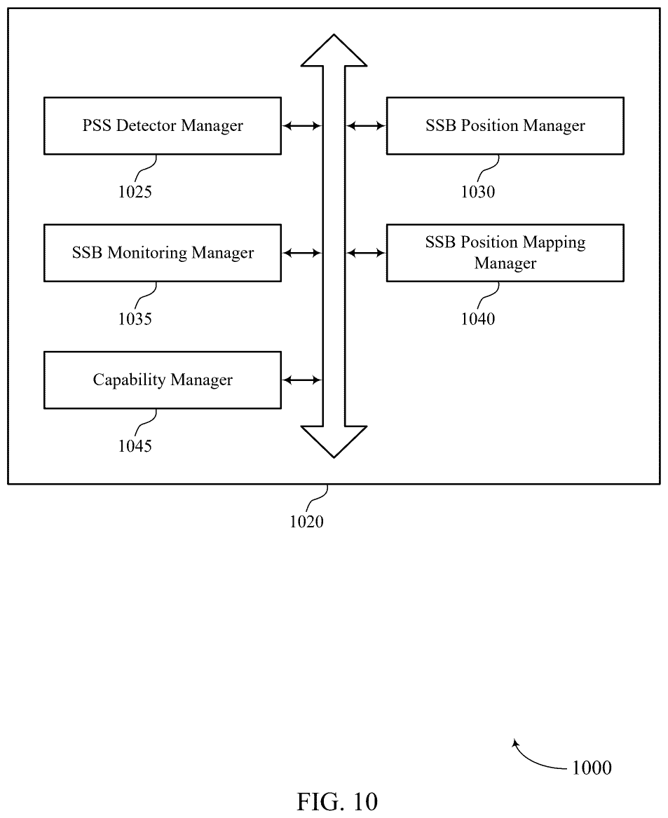

FIG. 10 shows a block diagram 1000 of a communications manager 1020 that supports techniques for synchronization signal block detection based on primary synchronization signal synchronization signal block range signaling in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for synchronization signal block detection based on primary synchronization signal synchronization signal block range signaling as described herein. For example, the communications manager 1020 may include an PSS detector manager 1025, an SSB position manager 1030, an SSB monitoring manager 1035, an SSB position mapping manager 1040, a capability manager 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The PSS detector manager 1025 is capable of, configured to, or operable to support a means for detecting, based on a signal quality measurement, a first PSS from a set of multiple PSSs of a PSS burst, where the set of multiple PSSs correspond to a set of multiple SSBs scheduled within an SSB detection window. The SSB position manager 1030 is capable of, configured to, or operable to support a means for decoding, within a time duration corresponding to the first PSS, one or more resource blocks to identify an SSB position ID, where the SSB position ID maps to a subset of SSB IDs of a set of multiple SSB IDs corresponding to the set of multiple SSBs, where the subset of SSB IDs include two or more SSB IDs. The SSB monitoring manager 1035 is capable of, configured to, or operable to support a means for monitoring, during a portion of the SSB detection window including the subset of SSB IDs, for a first SSB corresponding to the first PSS.

In some examples, the SSB position mapping manager 1040 is capable of, configured to, or operable to support a means for receiving, via control signaling, an indication of a mapping that associates SSB position IDs to corresponding subsets of SSB IDs, an indication of a mapping rule for determining the mapping that associates SSB position IDs to corresponding subsets of SSB IDs, or both.

In some examples, the UE is preconfigured with a mapping that associates SSB position IDs to corresponding subsets of SSB IDs, or preconfigured with a mapping rule for determining the mapping that associates SSB position IDs to corresponding subsets of SSB IDs, or both.

In some examples, the one or more resource blocks including the SSB position ID are frequency division multiplexed in a same symbol as the first PSS.

In some examples, the SSB position ID is indicated in a quantity of bits carried in the one or more resource blocks.

In some examples, the quantity of bits indicating the SSB position ID is based on a frequency range associated with the UE, a frequency associated with the UE, a sub-carrier spacing associated with the UE, a duplex capability associated with the UE, or any combination thereof.

In some examples, a quantity of SSB IDs in the subset of SSB IDs is based on the quantity of bits indicating the SSB position ID.

In some examples, the portion of the SSB detection window includes a reduced portion of the SSB detection window.

In some examples, the portion of the SSB detection window includes SSBs, of the set of multiple SSBs, that correspond to the subset of SSB IDs and, to support excludes one or more SSBs, of the set of multiple SSBs, that do not correspond to the subset of SSB IDs, and where monitoring for the first SSB corresponding to the first PSS, the SSB monitoring manager 1035 is capable of, configured to, or operable to support a means for decoding the SSBs that correspond to the subset of SSB IDs. In some examples, the portion of the SSB detection window includes SSBs, of the set of multiple SSBs, that correspond to the subset of SSB IDs and, to support excludes one or more SSBs, of the set of multiple SSBs, that do not correspond to the subset of SSB IDs, and where monitoring for the first SSB corresponding to the first PSS, the SSB monitoring manager 1035 is capable of, configured to, or operable to support a means for refraining from decoding the one or more SSBs that do not correspond to the subset of SSB IDs.

In some examples, to support monitoring for the first SSB corresponding to the first PSS, the SSB monitoring manager 1035 is capable of, configured to, or operable to support a means for detecting, based on decoding the SSBs that correspond to the subset of SSB IDs, the first SSB corresponding to the first PSS.

In some examples, to support monitoring for the first SSB corresponding to the first PSS, the SSB monitoring manager 1035 is capable of, configured to, or operable to support a means for determining, based on decoding the SSBs that correspond to the subset of SSB IDs, that the first SSB corresponding to the first PSS is not detected. In some examples, to support monitoring for the first SSB corresponding to the first PSS, the SSB monitoring manager 1035 is capable of, configured to, or operable to support a means for discarding, based on the first SSB not being detected, the first PSS. In some examples, to support monitoring for the first SSB corresponding to the first PSS, the SSB monitoring manager 1035 is capable of, configured to, or operable to support a means for monitoring, during a second SSB detection window, for a second set of multiple PSSs of a second PSS burst.

In some examples, the capability manager 1045 is capable of, configured to, or operable to support a means for receiving, from a network entity and via control signaling, a message indicating a capability for SSB ID range signaling.

In some examples, the capability manager 1045 is capable of, configured to, or operable to support a means for transmitting, to a network entity and via control signaling, a message indicating a capability to support SSB ID range signaling.

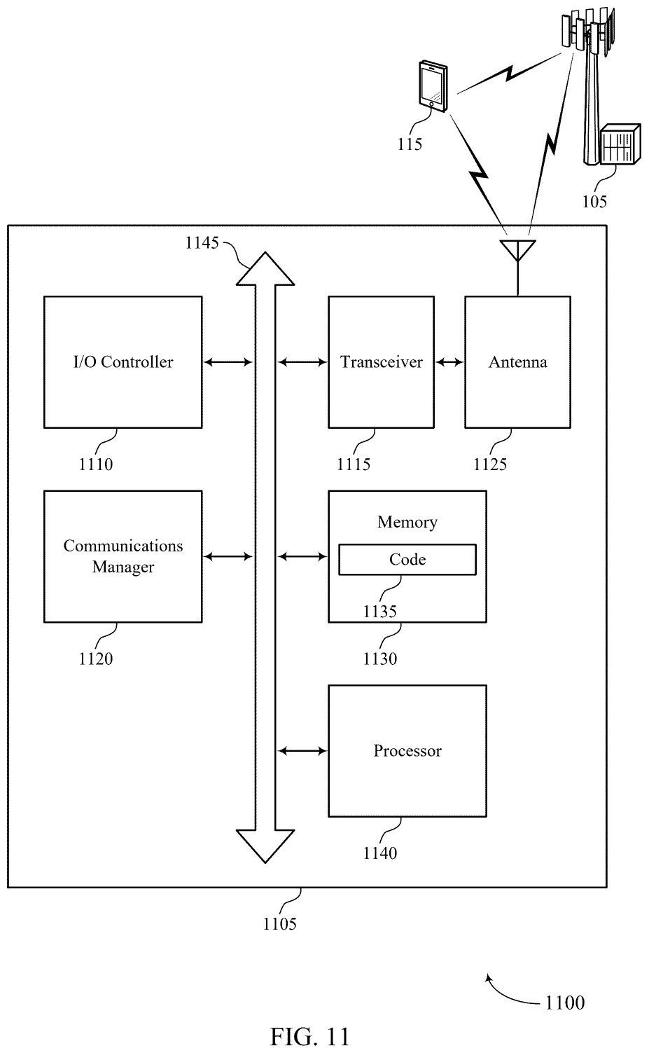

FIG. 11 shows a diagram of a system 1100 including a device 1105 that supports techniques for synchronization signal block detection based on primary synchronization signal synchronization signal block range signaling in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for synchronization signal block detection based on primary synchronization signal synchronization signal block range signaling). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for detecting, based on a signal quality measurement, a first PSS from a set of multiple PSSs of a PSS burst, where the set of multiple PSSs correspond to a set of multiple SSBs scheduled within an SSB detection window. The communications manager 1120 is capable of, configured to, or operable to support a means for decoding, within a time duration corresponding to the first PSS, one or more resource blocks to identify an SSB position ID, where the SSB position ID maps to a subset of SSB IDs of a set of multiple SSB IDs corresponding to the set of multiple SSBs, where the subset of SSB IDs include two or more SSB IDs. The communications manager 1120 is capable of, configured to, or operable to support a means for monitoring, during a portion of the SSB detection window including the subset of SSB IDs, for a first SSB corresponding to the first PSS.

By including or configuring the communications manager 1120 in accordance with examples as described herein, the device 1105 may support techniques for reduced latency, improved user experience related to reduced processing, reduced power consumption, and longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described herein with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for synchronization signal block detection based on primary synchronization signal synchronization signal block range signaling as described herein, or the at least one processor 1140 and the at least one memory 1130 may be otherwise configured to, individually or collectively, perform or support such operations.

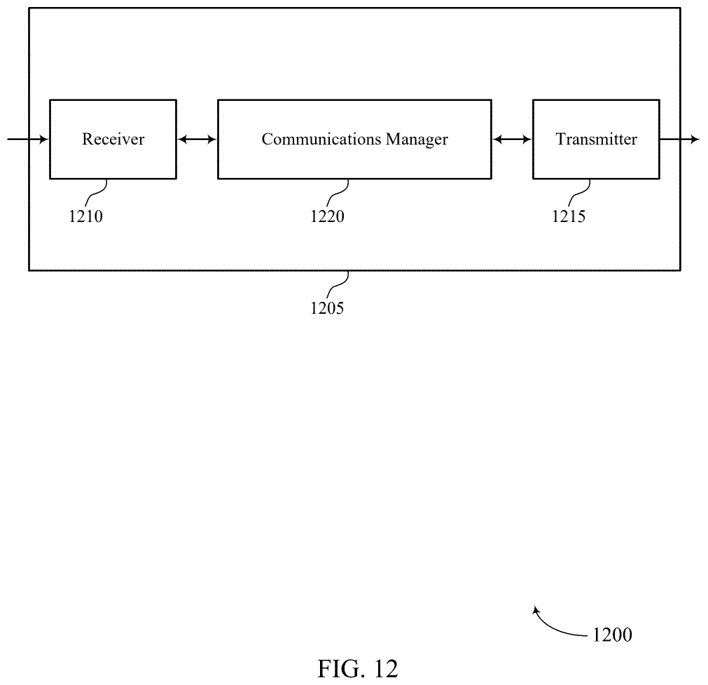

FIG. 12 shows a block diagram 1200 of a device 1205 that supports techniques for synchronization signal block detection based on primary synchronization signal synchronization signal block range signaling in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of techniques for synchronization signal block detection based on primary synchronization signal synchronization signal block range signaling as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting, to a UE, a PSS burst including a set of multiple PSSs, where the set of multiple PSSs correspond to a set of multiple SSBs scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs. The communications manager 1220 is capable of, configured to, or operable to support a means for outputting, to the UE during the SSB detection window, a SSB burst including the set of multiple SSBs. The communications manager 1220 is capable of, configured to, or operable to support a means for communicating with the UE on resources based on an SSB of the set of multiple SSBs.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced power consumption.

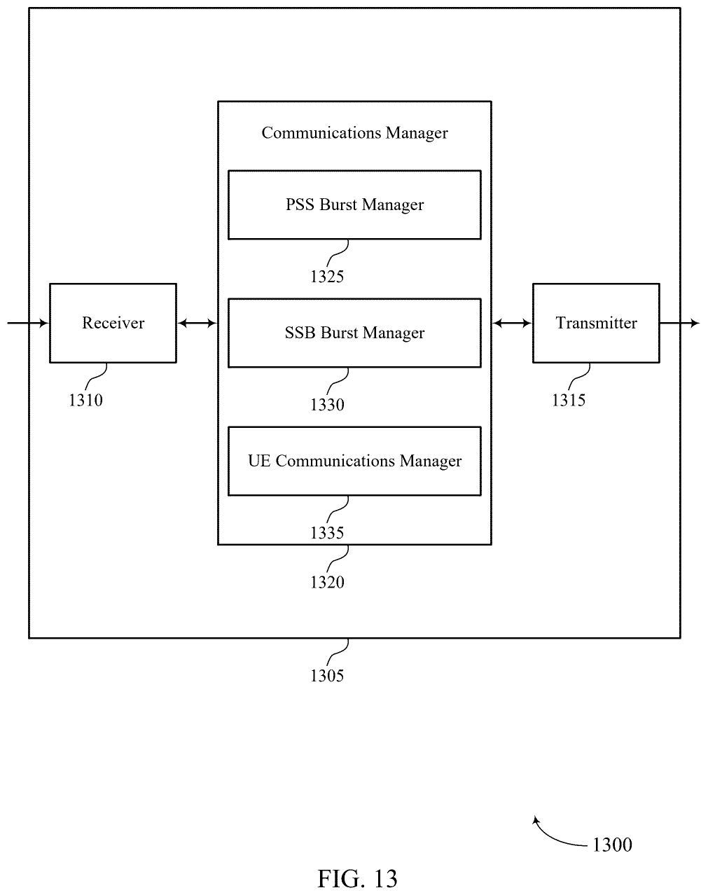

FIG. 13 shows a block diagram 1300 of a device 1305 that supports techniques for synchronization signal block detection based on primary synchronization signal synchronization signal block range signaling in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one of more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for synchronization signal block detection based on primary synchronization signal synchronization signal block range signaling as described herein. For example, the communications manager 1320 may include an PSS burst manager 1325, an SSB burst manager 1330, a UE communications manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The PSS burst manager 1325 is capable of, configured to, or operable to support a means for outputting, to a UE, a PSS burst including a set of multiple PSSs, where the set of multiple PSSs correspond to a set of multiple SSBs scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs. The SSB burst manager 1330 is capable of, configured to, or operable to support a means for outputting, to the UE during the SSB detection window, a SSB burst including the set of multiple SSBs. The UE communications manager 1335 is capable of, configured to, or operable to support a means for communicating with the UE on resources based on an SSB of the set of multiple SSBs.

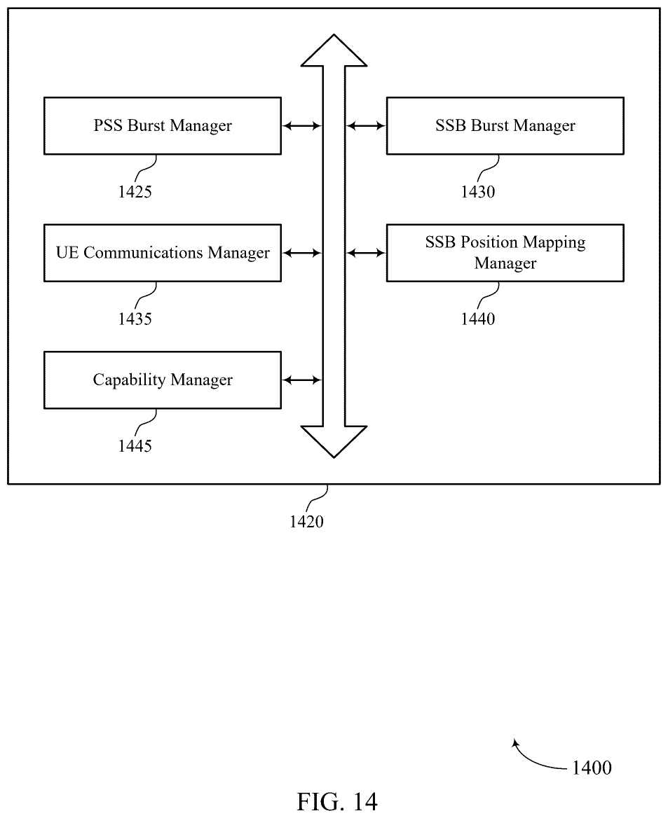

FIG. 14 shows a block diagram 1400 of a communications manager 1420 that supports techniques for synchronization signal block detection based on primary synchronization signal synchronization signal block range signaling in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for synchronization signal block detection based on primary synchronization signal synchronization signal block range signaling as described herein. For example, the communications manager 1420 may include an PSS burst manager 1425, an SSB burst manager 1430, a UE communications manager 1435, an SSB position mapping manager 1440, a capability manager 1445, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The PSS burst manager 1425 is capable of, configured to, or operable to support a means for outputting, to a UE, a PSS burst including a set of multiple PSSs, where the set of multiple PSSs correspond to a set of multiple SSBs scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs. The SSB burst manager 1430 is capable of, configured to, or operable to support a means for outputting, to the UE during the SSB detection window, a SSB burst including the set of multiple SSBs. The UE communications manager 1435 is capable of, configured to, or operable to support a means for communicating with the UE on resources based on an SSB of the set of multiple SSBs.

In some examples, the one or more resource blocks including the respective SSB position ID are frequency division multiplexed in a same symbol as an associated PSS.

In some examples, the respective SSB position ID is indicated in a quantity of bits carried in the one or more resource blocks.

In some examples, the quantity of bits indicating the respective SSB position ID is based on a frequency range associated with the UE, a frequency associated with the UE, a sub-carrier spacing associated with the UE, a duplex capability associated with the UE, or any combination thereof.

In some examples, a quantity of SSB IDs in the subset of SSB IDs is based on the quantity of bits indicating the respective SSB position ID.

In some examples, the SSB position mapping manager 1440 is capable of, configured to, or operable to support a means for outputting, to the UE and via control signaling, a mapping that associates SSB position IDs to corresponding subsets of SSB IDs, a mapping rule, or a combination thereof.

In some examples, the capability manager 1445 is capable of, configured to, or operable to support a means for outputting, to the UE and via control signaling, a message indicating a capability for SSB ID range signaling.

In some examples, the capability manager 1445 is capable of, configured to, or operable to support a means for obtaining, from the UE and via control signaling, a message indicating a capability to support SSB ID range signaling.

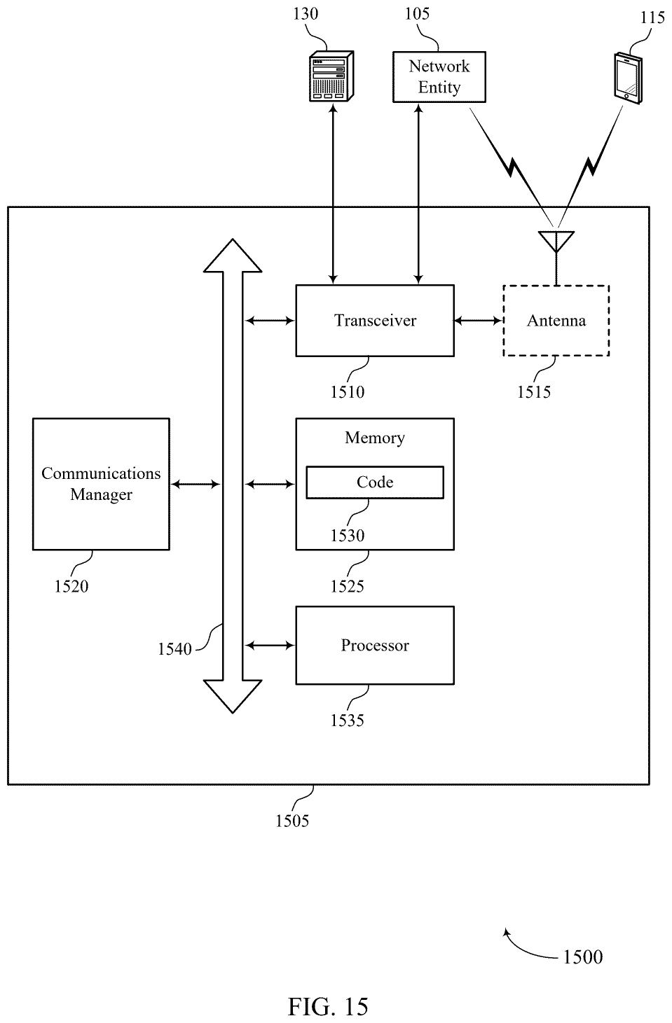

FIG. 15 shows a diagram of a system 1500 including a device 1505 that supports techniques for synchronization signal block detection based on primary synchronization signal synchronization signal block range signaling in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting techniques for synchronization signal block detection based on primary synchronization signal synchronization signal block range signaling). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting, to a UE, a PSS burst including a set of multiple PSSs, where the set of multiple PSSs correspond to a set of multiple SSBs scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs. The communications manager 1520 is capable of, configured to, or operable to support a means for outputting, to the UE during the SSB detection window, a SSB burst including the set of multiple SSBs. The communications manager 1520 is capable of, configured to, or operable to support a means for communicating with the UE on resources based on an SSB of the set of multiple SSBs.

By including or configuring the communications manager 1520 in accordance with examples as described herein, the device 1505 may support techniques for reduced latency, improved user experience related to reduced processing, reduced power consumption, and longer battery life.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described herein with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of techniques for synchronization signal block detection based on primary synchronization signal synchronization signal block range signaling as described herein, or the at least one processor 1535 and the at least one memory 1525 may be otherwise configured to, individually or collectively, perform or support such operations.

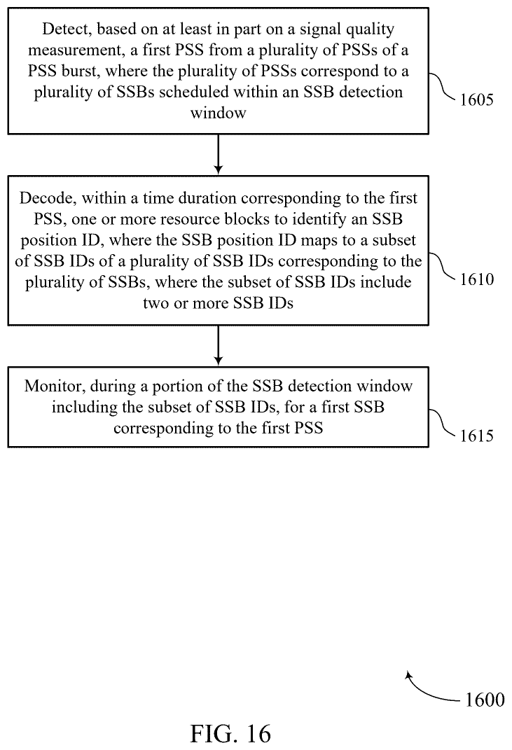

FIG. 16 shows a flowchart illustrating a method 1600 that supports techniques for synchronization signal block detection based on primary synchronization signal synchronization signal block range signaling in accordance with one or more aspects of the present disclosure. The operations of the method 1600 may be implemented by a UE or its components as described herein. For example, the operations of the method 1600 may be performed by a UE 115 as described herein with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include detecting, based on a signal quality measurement, a first PSS from a set of multiple PSSs of a PSS burst, where the set of multiple PSSs correspond to a set of multiple SSBs scheduled within an SSB detection window. The operations of 1605 may be performed in accordance with examples as disclosed herein. In some examples, aspects of the operations of 1605 may be performed by an PSS detector manager 1025 as described herein with reference to FIG. 10.

At 1610, the method may include decoding, within a time duration corresponding to the first PSS, one or more resource blocks to identify an SSB position ID, where the SSB position ID maps to a subset of SSB IDs of a set of multiple SSB IDs corresponding to the set of multiple SSBs, where the subset of SSB IDs include two or more SSB IDs. The operations of 1610 may be performed in accordance with examples as disclosed herein. In some examples, aspects of the operations of 1610 may be performed by an SSB position manager 1030 as described herein with reference to FIG. 10.

At 1615, the method may include monitoring, during a portion of the SSB detection window including the subset of SSB IDs, for a first SSB corresponding to the first PSS. The operations of 1615 may be performed in accordance with examples as disclosed herein. In some examples, aspects of the operations of 1615 may be performed by an SSB monitoring manager 1035 as described herein with reference to FIG. 10.

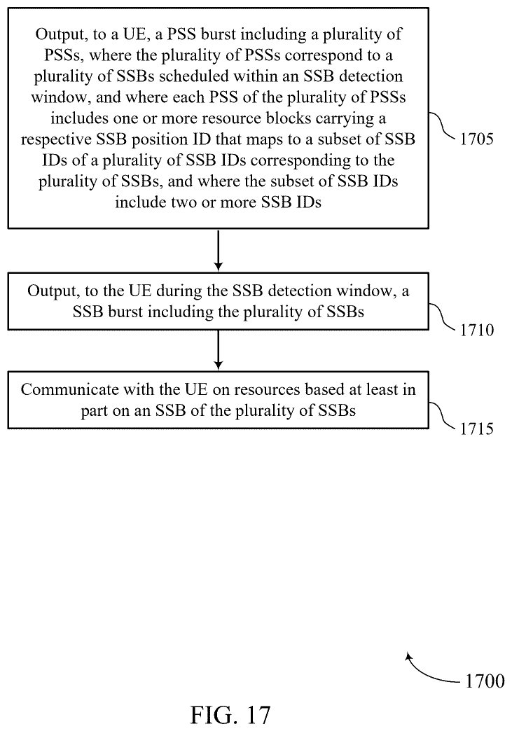

FIG. 17 shows a flowchart illustrating a method 1700 that supports techniques for synchronization signal block detection based on primary synchronization signal synchronization signal block range signaling in accordance with one or more aspects of the present disclosure. The operations of the method 1700 may be implemented by a network entity or its components as described herein. For example, the operations of the method 1700 may be performed by a network entity as described herein with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, a PSS burst including a set of multiple PSSs, where the set of multiple PSSs correspond to a set of multiple synchronization signal blocks (SSBs scheduled within an SSB detection window, and where each PSS of the set of multiple PSSs includes one or more resource blocks carrying a respective SSB position ID that maps to a subset of SSB IDs of a set of multiple SSB IDs corresponding to the set of multiple SSBs, and where the subset of SSB IDs include two or more SSB IDs. The operations of 1705 may be performed in accordance with examples as disclosed herein. In some examples, aspects of the operations of 1705 may be performed by an PSS burst manager 1425 as described herein with reference to FIG. 14.

At 1710, the method may include outputting, to the UE during the SSB detection window, a SSB burst including the set of multiple SSBs. The operations of 1710 may be performed in accordance with examples as disclosed herein. In some examples, aspects of the operations of 1710 may be performed by an SSB burst manager 1430 as described herein with reference to FIG. 14.

At 1715, the method may include communicating with the UE on resources based on an SSB of the set of multiple SSBs. The operations of 1715 may be performed in accordance with examples as disclosed herein. In some examples, aspects of the operations of 1715 may be performed by a UE communications manager 1435 as described herein with reference to FIG. 14.

The following provides an overview of aspects of the present disclosure:

Aspect 1: A method for wireless communications by a UE, comprising: detecting, based at least in part on a signal quality measurement, a first PSS from a plurality of PSSs of a PSS burst, wherein the plurality of PSSs correspond to a plurality of synchronization signal blocks (SSBs) scheduled within an SSB detection window; decoding, within a time duration corresponding to the first PSS, one or more resource blocks to identify an SSB position identification (ID), wherein the SSB position ID maps to a subset of SSB IDs of a plurality of SSB IDs corresponding to the plurality of SSBs, wherein the subset of SSB IDs comprise two or more SSB IDs; and monitoring, during a portion of the SSB detection window comprising the subset of SSB IDs, for a first SSB corresponding to the first PSS.

Aspect 2: The method of aspect 1, further comprising: receiving, via control signaling, an indication of a mapping that associates SSB position IDs to corresponding subsets of SSB IDs, an indication of a mapping rule for determining the mapping that associates SSB position IDs to corresponding subsets of SSB IDs, or both.

Aspect 3: The method of any of aspects 1 through 2, wherein the UE is preconfigured with a mapping that associates SSB position IDs to corresponding subsets of SSB IDs, or preconfigured with a mapping rule for determining the mapping that associates SSB position IDs to corresponding subsets of SSB IDs, or both.

Aspect 4: The method of any of aspects 1 through 3, wherein the one or more resource blocks comprising the SSB position ID are frequency division multiplexed in a same symbol as the first PSS.

Aspect 5: The method of any of aspects 1 through 4, wherein the SSB position ID is indicated in a quantity of bits carried in the one or more resource blocks.

Aspect 6: The method of aspect 5, wherein the quantity of bits indicating the SSB position ID is based at least in part on a frequency range associated with the UE, a frequency associated with the UE, a sub-carrier spacing associated with the UE, a duplex capability associated with the UE, or any combination thereof.

Aspect 7: The method of any of aspects 5 through 6, wherein a quantity of SSB IDs in the subset of SSB IDs is based at least in part on the quantity of bits indicating the SSB position ID.

Aspect 8: The method of any of aspects 1 through 7, wherein the portion of the SSB detection window comprises a reduced portion of the SSB detection window.

Aspect 9: The method of any of aspects 1 through 8, wherein the portion of the SSB detection window comprises SSBs, of the plurality of SSBs, that correspond to the subset of SSB IDs and excludes one or more SSBs, of the plurality of SSBs, that do not correspond to the subset of SSB IDs, and wherein monitoring for the first SSB corresponding to the first PSS comprises: decoding the SSBs that correspond to the subset of SSB IDs; and refraining from decoding the one or more SSBs that do not correspond to the subset of SSB IDs.

Aspect 10: The method of aspect 9, wherein monitoring for the first SSB corresponding to the first PSS comprises: detecting, based at least in part on decoding the SSBs that correspond to the subset of SSB IDs, the first SSB corresponding to the first PSS.

Aspect 11: The method of any of aspects 9 through 10, wherein monitoring for the first SSB corresponding to the first PSS comprises: determining, based at least in part on decoding the SSBs that correspond to the subset of SSB IDs, that the first SSB corresponding to the first PSS is not detected; discarding, based on the first SSB not being detected, the first PSS; and monitoring, during a second SSB detection window, for a second plurality of PSSs of a second PSS burst.

Aspect 12: The method of any of aspects 1 through 11, further comprising: receiving, from a network entity and via control signaling, a message indicating a capability for SSB ID range signaling.

Aspect 13: The method of any of aspects 1 through 12, further comprising: transmitting, to a network entity and via control signaling, a message indicating a capability to support SSB ID range signaling.

Aspect 14: A method for wireless communications by a network entity, comprising: outputting, to a UE, a primary synchronization symbol (PSS) burst comprising a plurality of PSSs, wherein the plurality of PSSs correspond to a plurality of synchronization signal blocks (SSBs) scheduled within an SSB detection window, and wherein each PSS of the plurality of PSSs comprises one or more resource blocks carrying a respective SSB position ID that maps to a subset of SSB IDs of a plurality of SSB IDs corresponding to the plurality of SSBs, and wherein the subset of SSB IDs comprise two or more SSB IDs; outputting, to the UE during the SSB detection window, a SSB burst comprising the plurality of SSBs; communicating with the UE on resources based at least in part on an SSB of the plurality of SSBs.

Aspect 15: The method of aspect 14, wherein the one or more resource blocks comprising the respective SSB position ID are frequency division multiplexed in a same symbol as an associated PSS.

Aspect 16: The method of aspect 15, wherein the respective SSB position ID is indicated in a quantity of bits carried in the one or more resource blocks.

Aspect 17: The method of aspect 16, wherein the quantity of bits indicating the respective SSB position ID is based at least in part on a frequency range associated with the UE, a frequency associated with the UE, a sub-carrier spacing associated with the UE, a duplex capability associated with the UE, or any combination thereof.

Aspect 18: The method of any of aspects 16 through 17, wherein a quantity of SSB IDs in the subset of SSB IDs is based at least in part on the quantity of bits indicating the respective SSB position ID.

Aspect 19: The method of any of aspects 14 through 18, further comprising: outputting, to the UE and via control signaling, a mapping that associates SSB position IDs to corresponding subsets of SSB IDs, a mapping rule, or a combination thereof.

Aspect 20: The method of any of aspects 14 through 19, further comprising: outputting, to the UE and via control signaling, a message indicating a capability for SSB ID range signaling.

Aspect 21: The method of any of aspects 14 through 20, further comprising: obtaining, from the UE and via control signaling, a message indicating a capability to support SSB ID range signaling.

Aspect 22: A UE for wireless communications, comprising one or more memories storing processor-executable code, and one or more processors coupled with the one or more memories and individually or collectively operable to execute the code to cause the UE to perform a method of any of aspects 1 through 13.

Aspect 23: A UE for wireless communications, comprising at least one means for performing a method of any of aspects 1 through 13.

Aspect 24: A non-transitory computer-readable medium storing code for wireless communications, the code comprising instructions executable by one or more processors to perform a method of any of aspects 1 through 13.

Aspect 25: A network entity for wireless communications, comprising one or more memories storing processor-executable code, and one or more processors coupled with the one or more memories and individually or collectively operable to execute the code to cause the network entity to perform a method of any of aspects 14 through 21.

Aspect 26: A network entity for wireless communications, comprising at least one means for performing a method of any of aspects 14 through 21.

Aspect 27: A non-transitory computer-readable medium storing code for wireless communications, the code comprising instructions executable by one or more processors to perform a method of any of aspects 14 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
detect, based at least in part on a signal quality measurement, a first primary synchronization signal (PSS) from a plurality of PSSs of a PSS burst, wherein the plurality of PSSs correspond to a plurality of synchronization signal blocks (SSBs) scheduled within an SSB detection window;
decode, within a time duration corresponding to the first PSS, one or more resource blocks to identify an SSB position identifier (ID), wherein the SSB position ID maps to a subset of SSB IDs of a plurality of SSB IDs corresponding to the plurality of SSBs, wherein the subset of SSB IDs comprise two or more SSB IDs; and
monitor, during a portion of the SSB detection window comprising the subset of SSB IDs, for a first SSB corresponding to the first PSS.

2. The UE of claim 1, wherein the one or more processors are individually or collectively further operable to execute the code to cause the UE to:
receive, via control signaling, an indication of a mapping that associates SSB position IDs to corresponding subsets of SSB IDs, an indication of a mapping rule for determining the mapping that associates SSB position IDs to corresponding subsets of SSB IDs, or both.

3. The UE of claim 1, wherein the UE is preconfigured with a mapping that associates SSB position IDs to corresponding subsets of SSB IDs, or preconfigured with a mapping rule for determining the mapping that associates SSB position IDs to corresponding subsets of SSB IDs, or both.

4. The UE of claim 1, wherein the one or more resource blocks comprising the SSB position ID are frequency division multiplexed in a same symbol as the first PSS.

5. The UE of claim 1, wherein the SSB position ID is indicated in a quantity of bits carried in the one or more resource blocks, wherein the quantity of bits indicating the SSB position ID is based at least in part on a frequency range associated with the UE, a frequency associated with the UE, a sub-carrier spacing associated with the UE, a duplex capability associated with the UE, or any combination thereof.

6. The UE of claim 1, wherein the portion of the SSB detection window comprises SSBs, of the plurality of SSBs, that correspond to the subset of SSB IDs, and, to exclude one or more SSBs, of the plurality of SSBs, that do not correspond to the subset of SSB IDs, and wherein monitoring for the first SSB corresponding to the first PSS, the one or more processors are individually or collectively operable to execute the code to cause the UE to:
decode the SSBs that correspond to the subset of SSB IDs; and
refrain from decoding the one or more SSBs that do not correspond to the subset of SSB IDs.

7. The UE of claim 6, wherein, to monitor for the first SSB corresponding to the first PSS, the one or more processors are individually or collectively operable to execute the code to cause the UE to:
determine, based at least in part on decoding the SSBs that correspond to the subset of SSB IDs, that the first SSB corresponding to the first PSS is not detected;
discard, based on the first SSB not being detected, the first PSS; and
monitor, during a second SSB detection window, for a second plurality of PSSs of a second PSS burst.

8. The UE of claim 1, wherein the one or more processors are individually or collectively further operable to execute the code to cause the UE to:
receive, from a network entity and via control signaling, a message indicating a capability for SSB ID range signaling.

9. The UE of claim 1, wherein the one or more processors are individually or collectively further operable to execute the code to cause the UE to:
transmit, to a network entity and via control signaling, a message indicating a capability to support SSB ID range signaling.

10. A network entity, comprising:
one or more memories storing processor-executable code; and
one or more processors coupled with the one or more memories and individually or collectively operable to execute the code to cause the network entity to:
output, to a user equipment (UE), a primary synchronization symbol (PSS) burst comprising a plurality of PSSs, wherein the plurality of PSSs correspond to a plurality of synchronization signal blocks (SSBs) scheduled within an SSB detection window, and wherein each PSS of the plurality of PSSs comprises one or more resource blocks carrying a respective SSB position identifier (ID) that maps to a subset of SSB IDs of a plurality of SSB IDs corresponding to the plurality of SSBs, and wherein the subset of SSB IDs comprise two or more SSB IDs;
output, to the UE during the SSB detection window, a SSB burst comprising the plurality of SSBs; and
communicate with the UE on resources based at least in part on an SSB of the plurality of SSBs.

11. The network entity of claim 10, wherein the one or more resource blocks comprising the respective SSB position ID are frequency division multiplexed in a same symbol as an associated PSS.

12. The network entity of claim 11, wherein the respective SSB position ID is indicated in a quantity of bits carried in the one or more resource blocks, wherein the quantity of bits indicating the respective SSB position ID is based at least in part on a frequency range associated with the UE, a frequency associated with the UE, a sub-carrier spacing associated with the UE, a duplex capability associated with the UE, or any combination thereof.

13. The network entity of claim 10, wherein the one or more processors are individually or collectively further operable to execute the code to cause the network entity to:
output, to the UE and via control signaling, a mapping that associates SSB position IDs to corresponding subsets of SSB IDs, a mapping rule, or a combination thereof.

14. The network entity of claim 10, wherein the one or more processors are individually or collectively further operable to execute the code to cause the network entity to:
output, to the UE and via control signaling, a message indicating a capability for SSB ID range signaling.

15. The network entity of claim 10, wherein the one or more processors are individually or collectively further operable to execute the code to cause the network entity to:
obtain, from the UE and via control signaling, a message indicating a capability to support SSB ID range signaling.

16. A method for wireless communications by a user equipment (UE), comprising:
detecting, based at least in part on a signal quality measurement, a first primary synchronization signal (PSS) from a plurality of PSSs of a PSS burst, wherein the plurality of PSSs correspond to a plurality of synchronization signal blocks (SSBs) scheduled within an SSB detection window;
decoding, within a time duration corresponding to the first PSS, one or more resource blocks to identify an SSB position identifier (ID), wherein the SSB position ID maps to a subset of SSB IDs of a plurality of SSB IDs corresponding to the plurality of SSBs, wherein the subset of SSB IDs comprise two or more SSB IDs; and
monitoring, during a portion of the SSB detection window comprising the subset of SSB IDs, for a first SSB corresponding to the first PSS.

17. The method of claim 16, further comprising:
receiving, via control signaling, an indication of a mapping that associates SSB position IDs to corresponding subsets of SSB IDs, an indication of a mapping rule for determining the mapping that associates SSB position IDs to corresponding subsets of SSB IDs, or both.

18. The method of claim 16, wherein the UE is preconfigured with a mapping that associates SSB position IDs to corresponding subsets of SSB IDs, or preconfigured with a mapping rule for determining the mapping that associates SSB position IDs to corresponding subsets of SSB IDs, or both.

19. The method of claim 16, wherein the one or more resource blocks comprising the SSB position ID are frequency division multiplexed in a same symbol as the first PSS.

20. The method of claim 16, wherein the SSB position ID is indicated in a quantity of bits carried in the one or more resource blocks, wherein the quantity of bits indicating the SSB position ID is based at least in part on a frequency range associated with the UE, a frequency associated with the UE, a sub-carrier spacing associated with the UE, a duplex capability associated with the UE, or any combination thereof.

21. The method of claim 16, wherein the portion of the SSB detection window comprises SSBs, of the plurality of SSBs, that correspond to the subset of SSB IDs and excludes one or more SSBs, of the plurality of SSBs, that do not correspond to the subset of SSB IDs, and wherein monitoring for the first SSB corresponding to the first PSS comprises:
decoding the SSBs that correspond to the subset of SSB IDs; and
refraining from decoding the one or more SSBs that do not correspond to the subset of SSB IDs.

22. The method of claim 21, wherein monitoring for the first SSB corresponding to the first PSS comprises:
determining, based at least in part on decoding the SSBs that correspond to the subset of SSB IDs, that the first SSB corresponding to the first PSS is not detected;
discarding, based on the first SSB not being detected, the first PSS; and
monitoring, during a second SSB detection window, for a second plurality of PSSs of a second PSS burst.

23. The method of claim 16, further comprising:
receiving, from a network entity and via control signaling, a message indicating a capability for SSB ID range signaling.

24. The method of claim 16, further comprising:
transmitting, to a network entity and via control signaling, a message indicating a capability to support SSB ID range signaling.

25. A method for wireless communications by a network entity, comprising:
outputting, to a user equipment (UE), a primary synchronization symbol (PSS) burst comprising a plurality of PSSs, wherein the plurality of PSSs correspond to a plurality of synchronization signal blocks (SSBs) scheduled within an SSB detection window, and wherein each PSS of the plurality of PSSs comprises one or more resource blocks carrying a respective SSB position identifier (ID) that maps to a subset of SSB IDs of a plurality of SSB IDs corresponding to the plurality of SSBs, and wherein the subset of SSB IDs comprise two or more SSB IDs;
outputting, to the UE during the SSB detection window, a SSB burst comprising the plurality of SSBs; and
communicating with the UE on resources based at least in part on an SSB of the plurality of SSBs.

26. The method of claim 25, wherein the one or more resource blocks comprising the respective SSB position ID are frequency division multiplexed in a same symbol as an associated PSS.

27. The method of claim 26, wherein the respective SSB position ID is indicated in a quantity of bits carried in the one or more resource blocks, wherein the quantity of bits indicating the respective SSB position ID is based at least in part on a frequency range associated with the UE, a frequency associated with the UE, a sub-carrier spacing associated with the UE, a duplex capability associated with the UE, or any combination thereof.

28. The method of claim 25, further comprising:
outputting, to the UE and via control signaling, a mapping that associates SSB position IDs to corresponding subsets of SSB IDs, a mapping rule, or a combination thereof.

29. The method of claim 25, further comprising:
outputting, to the UE and via control signaling, a message indicating a capability for SSB ID range signaling.

30. The method of claim 25, further comprising:
obtaining, from the UE and via control signaling, a message indicating a capability to support SSB ID range signaling.
